(19) United States
(12) Patent Application Publication
(10) Pub. No.: US 2024/0412188 A1
(43) Pub. Date: Dec. 12, 2024

(54) IMAGE ANALYSIS METHODS AND ARRANGEMENTS

(71) Applicant: Digimarc Corporation, Beaverton, OR (US)

(72) Inventors: Vojtech Holub, Lafayette, CO (US); Tomas Filler, Beaverton, OR (US); Eric D. Evans, Portland, OR (US); Alexander Hull, Hillsboro, OR (US); Ethan Lyons, Bellevue, WA (US); Daniel J. Stotts, Beaverton, OR (US); Christopher M. Haverkate, Newberg, OR (US); Nicholas Anderson, Colorado Springs, CO (US); Dimitris Chachlakis, Tigard, OR (US)

(21) Appl. No.: 18/639,588

(22) Filed: Apr. 18, 2024

Related U.S. Application Data
(63) Continuation of application No. PCT/US23/73330, filed on Sep. 1, 2023.
(60) Provisional application No. 63/404,908, filed on Sep. 8, 2022.
(60) Provisional application No. 63/416,424, filed on Oct. 14, 2022.
(60) Provisional application No. 63/431,955, filed on Dec. 12, 2022.
(60) Provisional application No. 63/435,188, filed on Dec. 23, 2022.
(60) Provisional application No. 63/484,175, filed on Feb. 9, 2023.

(51) Int. Cl. G06Q 20/20; G06K 7/14; G06V 10/25; G06V 10/26

(52) U.S. Cl. CPC G06Q 20/208; G06K 7/1447; G06V 10/25; G06V 10/26

(57) ABSTRACT

A retail checkout system decodes machine-readable indicia from a composite image frame produced from a sequence of captured image frames. Different regions in the composite image are derived from different ones of the image frames in the captured sequence. Another embodiment generates a composite image frame from image frames captured with different camera focus settings. Still other embodiments concern neural networks, including their training to segment different items presented on a retail checkout surface. Other neural network embodiments discern on which of two items a machine readable indicia appears, when the visual context is ambiguous. A variety of other features and arrangements are also detailed.

### RELATED APPLICATION DATA

This application is a nationalization of PCT Application No. PCT/US2023/073330, filed Sep. 1, 2023 (published as WO 2024/054784), which claims priority to U.S. Provisional Patent Application Nos. 63/404,908, filed Sep. 8, 2022; 63/416,424, filed Oct. 14, 2022; 63/431,955, filed Dec. 12, 2022; 63/435,188, filed Dec. 23, 2022; and 63/484,175, filed Feb. 9, 2023. The disclosures of these above patent documents are each hereby incorporated herein by reference in its entirety.

### BACKGROUND

Checkout stations used in retail stores commonly use camera systems to identify products presented for purchase. In the prior art, these camera systems have had various shortcomings. The present technology improves checkout system camera systems to overcome certain of the prior art shortcomings.

A variety of embodiments are detailed in this disclosure. Some embodiments concern the generation and use of composite image frames, e.g., to reduce image noise without resort to better cameras, brighter light, etc.

One such embodiment is a method of generating a composite image frame. This method includes receiving a series of image frames depicting a scene. Each received frame includes a first region comprising a first set of pixels and a second, different, region comprising a second set of pixels. The series of frames includes frames J, K, L, M, in that order but not necessarily consecutively. The method includes accumulating, in a first memory, data corresponding to values of the first set of pixels from a count of P frames, from frame J through frame L, and accumulating, in a second memory, data corresponding to values of the second set of pixels from a count of Q frames, from frame K through frame M. By this arrangement, the Q frames include some but not all of said P frames. A composite frame is then produced using data stored in the first and second memories. A machine readable indicia can be decoded from the composite claim, and serve to identify an item presented for checkout by a shopper.

Another embodiment is a system for producing a composite image frame. Such a system can include a camera sensor, a memory, and means for processing multiple frames of imagery captured by the camera sensor to produce an output image frame comprised of plural image blocks. A first of these blocks is produced based on pixel data from P captured frames, and a second of these blocks is produced based on pixel data from Q captured frames, where the Q frames include some but not all of the P frames.

Still another such embodiment is a non-transitory data structure that stores a composite frame of image data which depicts a scene including a 2D code. This code, when decoded by a point-of-sale system, is operative to cause the system to add an item in the depicted scene to a shopper's checkout tally. The composite frame includes first, second, third and fourth blocks, each expressing information from a different collection of image frames captured by the code reader. The first block expresses information from a collection of P frames, and the second block expresses information from a collection of Q frames, where the Q frames include some but not all of the P frames.

The foregoing and other advantageous embodiments are detailed in the following description, which proceeds with reference to the accompanying drawings.

### BRIEF DESCRIPTION OF THE DRAWINGS

FIG. 1 shows elements of one embodiment.

FIG. 2 shows a series of video frames depicting objects being placed and removed from a checkout surface.

FIGS. 3A-3C illustrate accumulation of pixel data from different image bounding boxes.

FIGS. 4 and 5 detail variant arrangements that can be used in the embodiment depicted in FIGS. 3A-3C.

FIG. 6 shows a prior art checkout apparatus.

FIGS. 7A-7D show views captured by the apparatus of FIG. 6.

FIGS. 8A and 8B depict imagery captured by the apparatus of FIG. 6.

FIG. 9 shows another prior art checkout apparatus.

FIGS. 10A-10G show frames in a sequence of frames captured from a checkout surface, as items are presented for checkout.

FIG. 11 shows a sequence of frames defining two overlapping frame-count intervals, and assignment of frames from the two intervals to two memories.

FIGS. 12A and 12B illustrate aspects of an object counting embodiment.

FIG. 13 is a block diagram of one embodiment.

FIGS. 14, 15 and 16 illustrate different spatial relationships between items in captured image.

FIG. 17 shows a segmentation based on FIG. 16.

FIG. 18 shows bounding boxes associated with FIG. 16.

FIG. 19 illustrates that a 2D code depicted in imagery can lie within plural bounding boxes, introducing uncertainty about the item with which it is associated.

FIG. 20 shows one possible reality associated with the bounding boxes of FIG. 19.

FIG. 20A illustrates a segmentation of an occluded object.

FIG. 21 illustrates a spatial relationship between plural items in a captured image.

FIGS. 22, 23 and 24 illustrate different segmentations of the image of FIG. 21.

FIG. 25 illustrates how an occluded item can occlude a further item.

FIGS. 26 and 27 illustrate how a foreground object can introduce uncertainty about a count of items depicted in an image.

FIG. 28 shows a foreground object occluding one or more snack bags.

FIGS. 29 and 30 illustrate that occlusion does not always introduce uncertainty in scene segmentation.

FIG. 31 shows that information about object count in FIG. 28 can be gathered by decoding visible code information.

FIG. 32 illustrates how variation in watermark orientation is limited when rigid items are depicted in imagery.

FIG. 33 depicts a manually segmented image of an item.

FIG. 34 depicts an erroneous segmentation of the item of FIG. 33 FIG. 35 shows the intersection of the segmentations in FIGS. 33 and 34.

FIG. 36 shows the union of the segmentations in FIGS. 33 and 34.

FIG. 37 is an image depicting three boxes on a checkout surface.

FIG. 38 depicts a ground-truth segmentation, produced by a human from the image of FIG. 37.

FIGS. 39-41 illustrate different segmentation errors.

FIG. 42 depicts a training segmentation that can be used when one item is surrounded by pixels of a second item.

FIG. 43 depicts a training segmentation that can be used when one object occludes a second item, causing the second item to appear as two disjoint portions.

FIG. 44 is a depth map 3D representation of a checkout surface, showing distances to different item surfaces from the depth sensor.

FIG. 45 is a side view of the checkout surface of FIG. 44.

FIG. 46 shows an illustrative arrangement employing three cameras that view items on a checkout surface.

### DETAILED DESCRIPTION

One aspect of the present technology concerns reduction of image noise, which is especially problematic in systems using inexpensive image sensors, and in systems in which the subjects are not brightly-illuminated.

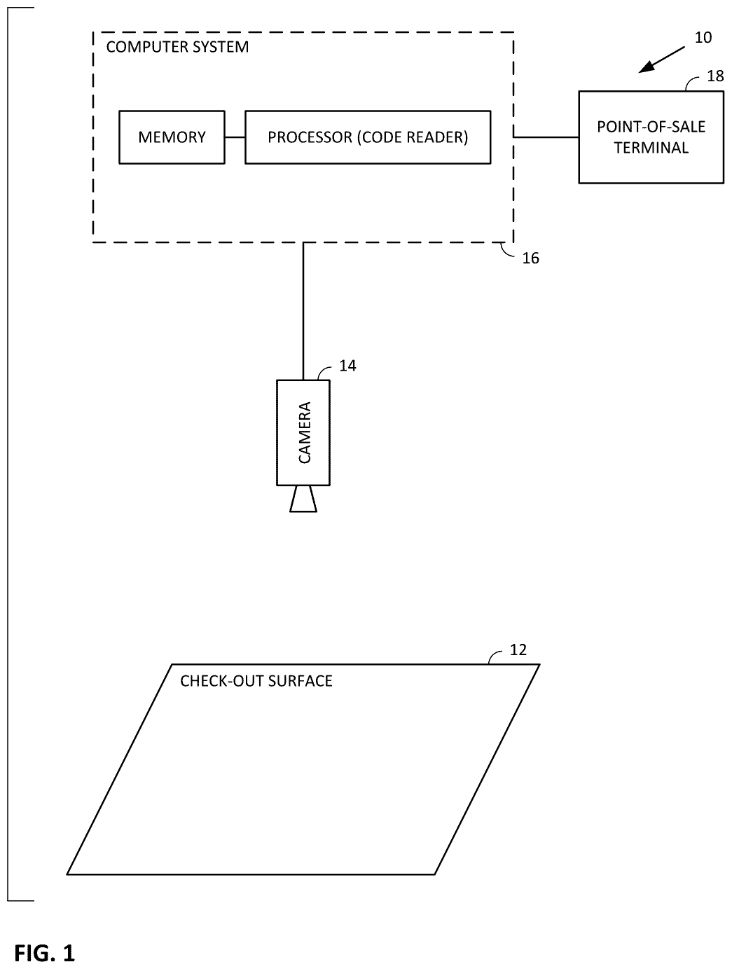

FIG. 1 shows a check-out station 10 for a retailer, such as a grocery store or dry goods store. A shopper unloads items from a basket or cart onto a surface 12 for viewing by a camera 14, before transferring the items to a bag or the like to take from the store. Image data from the camera is provided to a computer system 16, which identifies the items and passes identification data to a point of sale terminal 18 or other further system.

In one embodiment, the surface 12 can be a fixed table (stage) or a conveyor. The camera can comprise a CMOS sensor with a lens, aperture and exposure chosen to provide a depth of field that spans a volume extending up from the surface 12 to a height of about 20 or 30 centimeters. The imaging resolution can be on the order of at least 150 pixels per inch throughout the viewing volume. An illumination unit may optionally be provided to increase the illumination of items on the surface. If provided, such a source is strobed at a rate fast enough to appear as continuous illumination to human viewers (e.g., 30 frames per second or more). Strobes desirably are synchronized to the camera's frame-capture interval.

Suitable cameras are available, e.g., from OmniVision or Sony, and may have 8 or 12 megapixel resolution (e.g., the Sony IMX378 or IMX477), with photosensors on the order of one micron on a side. Fixed focus on auto-focus lenses may be used. (One suitable auto-focus lens employs a liquid lens approach, based on electrostatic deflection of oil-water.)

While a single camera is shown, there may be plural cameras. The illustrated camera is posed looking straight down towards the surface. Additionally or alternatively, there can be cameras having angled views of the surface, from sides or corners of the volume above the surface, and/or viewing up through a glass platen in the surface.

One or more of the cameras may be depth-sensing cameras. A suitable depth sensing camera is one from the Intel RealSense product line, such as the D435 camera. Alternatively, depth sensing can be achieved by use of a pair of cameras in a stereoscopic array, providing imagery to a processor running the DepthAI software library (available from the Luxonis github site) to extract depth information. Cameras suitable for this application may employ the OmniVision OV9281 sensors (1280×800 pixel resolution, with 3 micron photosensors). The depth information can be used to set the focal distance of the camera(s), if a variable focus lens is used. For example, if depth sensing is performed from above, proximate to a downward-facing camera, the distance to the nearest surface can be used to focus the camera to assure best focus of imagery captured from that surface.

For expository convenience, the following discussion focuses on processing of image data collected by a top-down-viewing camera 14. It will be recognized that similar principles are applicable to cameras having other viewpoints.

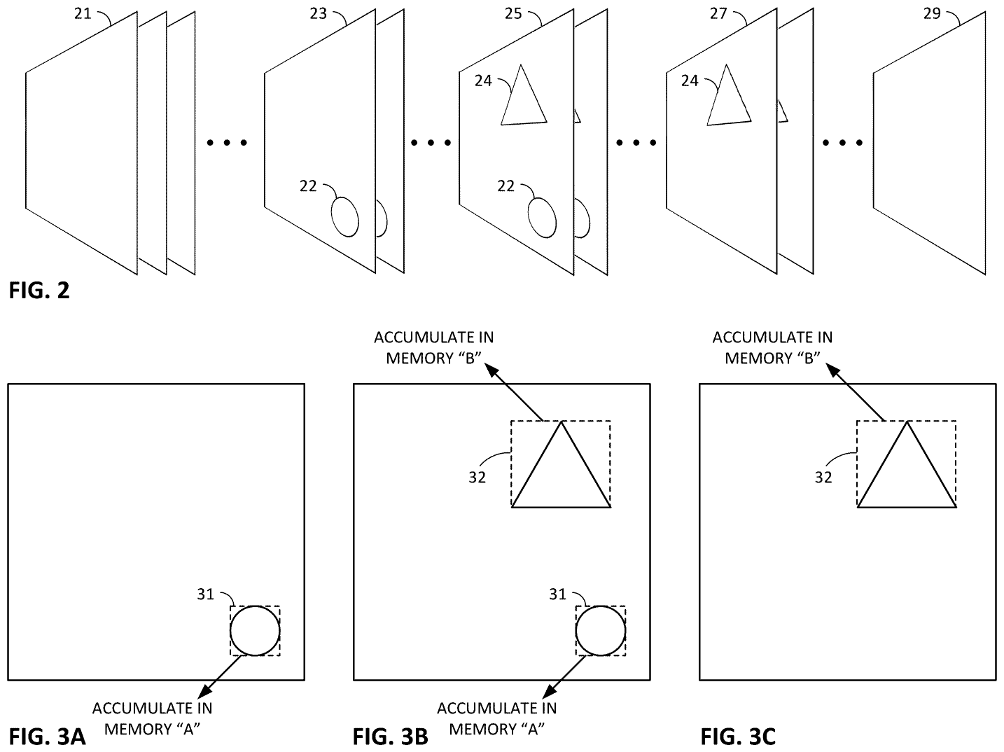

The camera 14 captures a sequence of 8- or 12-bit depth image frames, e.g., at a regular 10 or 30 frame-per-second cadence. Illustrative frames in the sequence are shown in FIG. 2. Initially the surface 12 is empty, as shown by frame 21. At some point, a shopper places an item 22 on the surface, which is first captured, in its static position, in frame 23. Several frames are captured with item 22 in this location.

A moment or two later, the shopper places an item 24 on the surface, which is first captured, in its static position, in frame 25. Imagery in following frames thus depict two items: item 22 and item 24.

At some point, the shopper first removes one of the items from the surface, e.g., into a bag, and then the other item. In FIG. 2 it is item 22 that is removed first. Frame 27 is the first of several frames then-captured with just item 24. A short time later the shopper also removes item 24 from the surface, leaving the surface empty. This is depicted in frame 29.

In accordance with one method employing aspects of the present technology, image frame 23, depicting the surface with item 22 placed at a location thereon, comprises P pixels (e.g., 12.3 megapixels). As shown in FIG. 3A, a bounding region 31 is identified that defines an excerpt, patch or sub-part of the P pixel image frame that encompasses depiction of the item 22. This bounding region may be rectangular, in which case it can be defined by the row/column coordinates of the pixel at the upper left corner of the region 31, and coordinates of the pixel at the lower right corner of the region. This excerpt comprises Q pixels, where Q<P. This Q-pixel patch of imagery is written to an associated area in the memory of FIG. 1.

Additional image frames are captured, depicting the check-out surface 12 with the item 22 static, at this same location. For each of these additional frames, a Q-pixel patch of imagery is identified by the just-noted bounding coordinates. Values of the Q pixels in this patch are summed with respective values earlier stored in the associated area of the memory.

At some point, an image frame is captured in which item 22 appears changed. It has been bumped or dislodged as the shopper begins to move the item for bagging, or the shopper's hand has briefly blocked (occluded) the camera view of the item as the shopper places or removes other items. This difference between two image frames in the sequence is detected. That is, the image data within the boundary coordinates changes by more than a threshold amount. This change triggers discontinuation of the former operation of summing the pixel values from the Q locations within the boundary coordinates with values earlier stored in the memory.

At this point, the memory may have summed (accumulated) M sets of pixel values within the boundary coordinates for five, ten, twenty, or more frames. The number of frames that have contributed summed data to the memory is counted, permitting the summed values to be divided by this count to generate an average pixel value for each pixel within the boundary 31.

After further accumulation has ended, the data in the memory, or data derived from such data (e.g., average pixel values) are provided for analysis, e.g., to a 2D code reader, which can be software executing on the processor(s). The code reader attempts to decode a payload from the patch of imagery represented by this data, and provides any extracted payload to a further process, such as a point-of-sale process.

The accumulation of pixel data in this fashion tends to reduce the influence of frame-to-frame variation (noise) in individual pixel values. Such noise is especially problematic if inexpensive, consumer-grade image sensors are employed, with small pixel areas and employing integrated image signal processors to filter or otherwise process pixel data (such as by gamma adjustment, white balance adjustment, etc.) to enhance the appearance of consumer photos (i.e., raw sensor data is unavailable). Yet the count of frames varies-depending on how long the item remains visible and stationary. If the item is left on the surface longer, data from more patches 31 of imagery are accumulated; if the item is removed from the surface more quickly, or if a passing hand or other obstacle interrupts the camera view, then data from fewer patches are accumulated.

It is not necessary for an average to be computed, as detailed. The raw data from the memory can be provided to the 2D code reader, which can be designed to deal with image data of an unknown range. For example, the reader software (or other software) can examine the array of data accumulated in the memory to determine the largest stored value. It can then divide each value in the memory by a power of two chosen to bring this largest stored value down to 255 or below. For example, if data are accumulated from patches in 10 frames, and the largest datum has a value of 2107, the reader can divide each input datum by 16 (i.e., by bit shifting four positions-discarding the four least significant bits of each datum) so the array has a largest value of 131. The resulting array of bit-shifted data can then be provided to code reading software designed to process eight bit data (i.e., values of 0-255). Note that the frame count is not used in this calculation.

Another method employing aspects of the present technology extends the foregoing method by introduction of a second item 24 onto the surface at a second location, while frames continue to be collected of the undisturbed and un-occluded first item 22. Accumulation of image data from the first patch 31 of imagery persists when the second item is added (assuming the user's hand does not occlude the view of item 22), because the second item 24 does not appear within the boundary 31 defined for the first item and thus does not trigger cessation of data accumulation. But the introduction of item 24 into frames of image data at the second location is noted (e.g., by comparison with previous frames showing different image data at that second location).

Second bounding box coordinates are identified that encompass the second location occupied by the second item 24 (i.e., defining area 32 in FIG. 3B). These second coordinates can encompass R pixels. After the image patch within the second bounding coordinates becomes stationary (e.g., using the test for motion identified herein), values of the R pixels are stored in a second area of memory (which can be termed memory “B,” as contrasted with the memory area “A,” in which pixel data for the first item, from patch 31, is accumulated).

Pixel values from following frames are then summed in memories “A” and “B,” from patches 31 and 32, respectively.

Eventually, one of the two items is moved, or its view is blocked, triggering cessation of further data accumulation in the memory associated with that item (e.g., as in FIG. 3C). And still later, the other of the two items is moved or its view is blocked, triggering cessation of further data accumulation in that item's associated memory. As before, after data accumulation in a memory area ceases, the accumulated data or a derivative (e.g., an average) can be provided to the 2D code reader for payload extraction.

The just-detailed arrangement is characterized, in part, in that the count of frames from which pixel values are summed in memory “A” is typically different than the count of frames from which pixel values are summed in memory “B.” Both counts depend on actions of the shopper. In an illustrative arrangement, pixel values may be summed in one memory across M image frames, and pixel values may be summed in another memory across N image frames, where N>M (and the N image frames can include some or all of the M image frames).

Sometimes an item may persist on the surface for an extended period of time. It is generally desirable to keep a checkout tally for the shopper relatively up-to-date. Accordingly, it can be desirable to provide accumulated image data from an item's bounding area to the code reader even before movement of the item triggers cessation of further data accumulation. Accordingly, another method employing aspects of the present technology maintains a count of the number of image frames from which pixel values have been summed in the memory, and if this count reaches a threshold value K, the accumulated data (or a derivative based thereon) is passed to the 2D code reader for payload extraction. K may be, e.g., 5, 10, 20 or 30 frames. The latter threshold will prompt the 2D code reader to extract and provide any associated payload to the point of sale system after the item has rested on the surface for one second. The associated memory area may be cleared and accumulation for the item may be started anew with the next frame. Alternatively, an average of the previously-accumulated data can be computed and stored as initial data in the memory, with pixel values from the next and following frames being summed with it.

In this arrangement, pixel data for some items are accumulated for frame counts dependent on shopper behavior, while pixel data for other items are accumulated for frame counts of K frames.

The foregoing arrangements rely on detecting when items are stationary (stable) on the viewing platform. This determination is commonly made by comparing pixel data in each frame to spatially-corresponding pixel data in a previous frame (e.g., the immediately-preceding frame, or an earlier frame), to determine if they match.

Due to camera noise, an identical scene will rarely provide identical pixel data in two different frames. For each camera sensor, a noise model can be determined (e.g., from published literature or from measurement) that indicates the statistical variation that can be expected from pixels. In determining whether two pixel values “match,” allowance must be made for this expected (permitted) noise margin.

Image sensor noise has various components, including Gaussian noise (aka thermal noise or Johnson-Nyquist noise) and shot noise. The latter tends to have a standard deviation that varies with the square root of image intensity. That is, more shot noise variation is expected from brightly-illuminated pixels (i.e., those with high values) than from dimly-illuminated pixels (i.e., those with low values).

In one embodiment, this variation-with-intensity is disregarded, and a fixed expected range of noise variation is used for all pixels in the sensor. This expected range of noise variation can be, e.g., 10 or 20 digital numbers—a value that can be based on the image noise model, or determined empirically. If the permitted variation value is 10, then a pixel value of 100 in one frame would “match” with pixel values of between 90 and 110 in a prior frame.

In another embodiment, the variation-with-intensity factor is included, so that pixels with higher values have higher expected noise margins than pixels with lower values. A lookup table can be provided to specify, for each possible pixel value in one frame (e.g., for values 0-255), a range of values in a prior frame that can “match.” An excerpt of such a table can look as follows:

| Pixel Value | Low Match Value | High Match Value |
|---|---|---|
| 0 | 0 | 5 |
| 1 | 0 | 6 |
| 2 | 0 | 7 |
| 3 | 0 | 8 |
| 4 | 0 | 9 |
| 5 | 0 | 10 |
| 6 | 1 | 11 |
| 7 | 2 | 12 |
| . . . | . . . | . . . |
| 120 | 112 | 129 |
| 121 | 113 | 130 |
| 122 | 114 | 131 |
| . . . | . . . | . . . |
| 220 | 208 | 232 |
| 221 | 209 | 233 |
| 222 | 210 | 234 |
| . . . | . . . | . . . |

As can be seen, for pixel values in the range 0-7, a variation of plus or minus 5 digital numbers still constitutes a match. For pixel values in the range of 120-122, a variation 8 digital numbers still constitutes a match. For pixel values in the range of 220-222, a variation of 12 digital numbers still constitutes a match. Other variations are also used, but omitted for brevity's sake.

In other embodiments, no look-up table is employed. Instead, a coarsely quantized variation is implemented with conditional statements in the software code, e.g., with a variation of 6 digital numbers being used for pixel values of 127 and less, and a variation of 10 digital numbers being used for pixel values of 128 and more.

It will be recognized that many variations are of course possible. One is to down-sample the imagery (e.g., by a factor of 20) to reduce changes due to random sensor noise, and then examine for frame-to-frame changes. Another is to rely on 3D sensor data (e.g., from a RealSense camera) to identify changes in the scene. Another is to examine changes in image statistics, e.g., as detailed in U.S. Pat. No. 10,958,807 (sometimes termed Block Trigger).

The comparison of values can be performed on a per-pixel basis, or on a per-pixel-patch basis. A patch can be any size. 8×1, 8×8, 32×32, and 256×256 pixel patches are exemplary. A patch may be compared to a previous spatially-corresponding patch on the basis of matches of its component pixels (with the expected value variations noted above). Two patches may be regarded as a match even if certain component pixels don't match. For example, an 8×8 pixel patch can be deemed to match with a corresponding patch in a previous frame even if one of the 64 pixels doesn't match its previous counterpart within the permitted noise margin. For a 32×32 pixel patch, a match can be found even if, e.g., 10 or 20 individual pixels don't match their counterparts. Forgiveness of such pixel mismatches is in acknowledgement that image noise is a statistical phenomenon, with most variation being within a single standard deviation, and the vast majority of variation being within two standard deviations, but sometimes outlier noise occurs, and a pixel value can be well outside usual norms. The number of such outlier pixels for which allowance should be made increases in accordance with the size of the patch, and the standard deviation of the image noise. In some embodiments, the comparison is speeded by use of parallelism provided by ARM and NEON processor instruction sets, e.g., considering pixels in arrays of 8×1, to determine frame-to-frame variation, based on corresponding row-to-row variation. The above-noted techniques all serve to determine the presence or absence of a match between two pixel regions, with a permitted noise margin.

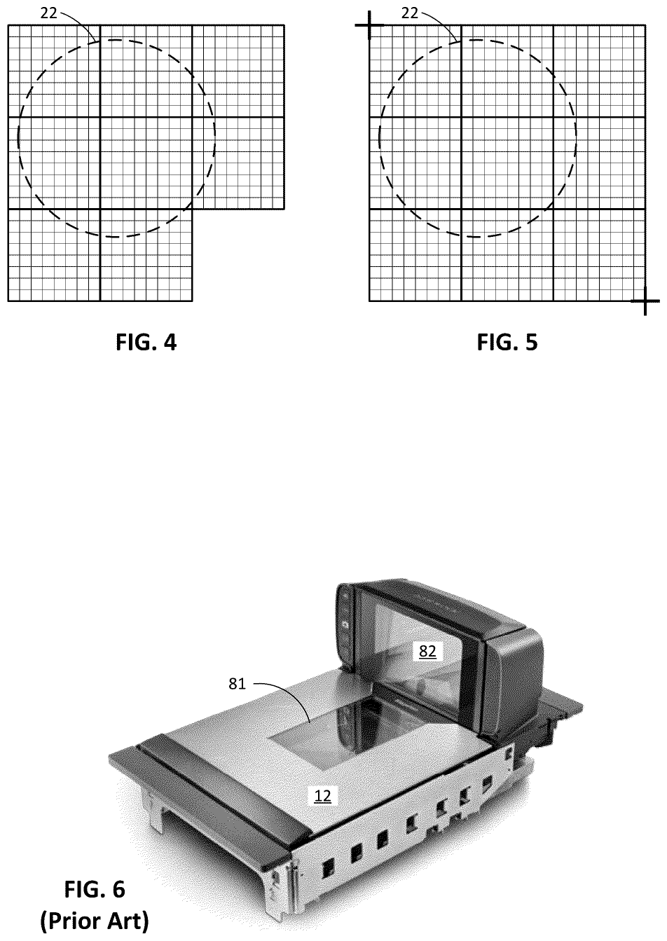

If object motion (or stability) detection is performed on the basis of image patches, then objects will have coarsely-defined shapes for purposes of image data accumulation. For example, the round shape 22 in FIG. 2 may have the quantized shape shown in FIG. 4, if 8×8 pixel patches are used. While image data from the eight depicted patches in FIG. 4 can be accumulated over multiple frames, more typically a rectangular bounding box is defined encompassing this shape (with corner point coordinates indicated by the graticules shown in FIG. 5), in which case image data from nine depicted patches can be accumulated.

In still other embodiments, patches are used in determining stability of an object on the surface, but matches are not determined based on matches of component pixels with prior values. Instead, values of all pixels within a patch are summed, and this value is compared with the sum of a spatially-corresponding patch in a previous frame to determine if they match. Again, the sums typically do not exactly equal each other; sums that are within a threshold value (a permitted noise margin) of each other are deemed to match. As before, the threshold for a match can be determined empirically, or based on a model of the image noise. Again, patches that match are regarded as indicating a stationary object, and such image data is summed across multiple frames so that a 2D code reading operation can be undertaken on the accumulated image data.

In determining item stability on the checkout surface (or motion), reference was made to comparing a pixel value (or block value) in a current image with a range of values associated with a pixel (block) value in a previous image. Naturally, the range of permitted variation can be applied to the pixel (block) value in the present image-rather than in the previous image—in determining a match.

In some embodiments, the checkout surface can include a glass window through which one or more cameras looks up at objects presented for checkout. In one particular such embodiment, a “bi-optic” scanner is used, such as the prior art Magellan 9400i scanner sold by Datalogic S.p.A. This scanner, shown in FIG. 6, includes a first camera that looks up through a horizontal glass window 81 (termed a “platen portion”), and a second camera that looks out from a vertical window 82 (in a “tower portion”).

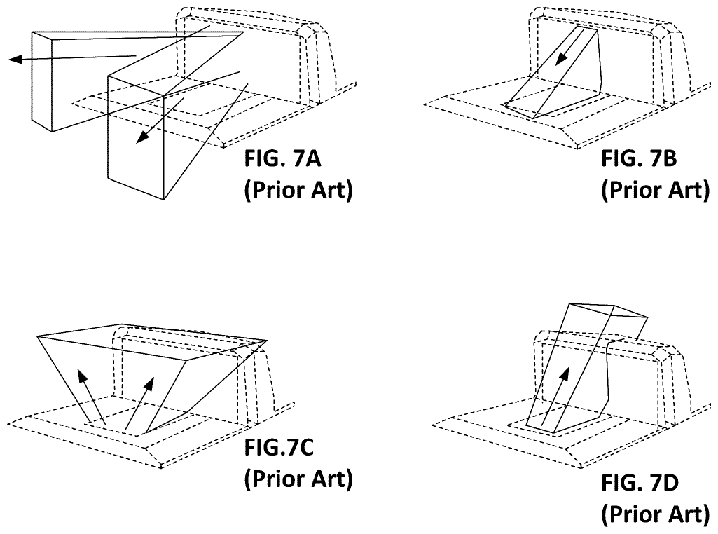

In an embodiment using the FIG. 6 scanner, an arrangement of mirrors projects several different views of a retail product onto different parts of a camera sensor in the platen portion 81. Likewise for the tower portion 82. In particular, the optics arrangement in the tower portion captures two views looking out horizontally from the mid-height of the window, at angles of roughly+/−45 degrees. These two view axes cross each other over the platen window, so as to capture two different views of an object placed on the window. This is illustrated in FIG. 7A. Another mirror arrangement provides a third viewpoint, looking down, at an angle of roughly 45 degrees, from near the top of the tower window. This is illustrated in FIG. 7B.

The three views, as projected onto the tower image sensor, are termed “facets.”

A similar mirror arrangement is employed in the platen portion 81. Two views look up from the window at angles of roughly+/−45 degrees. (Unlike the tower case, these two fields of view don't cross each other.) A third image is also captured by the platen camera sensor, looking up at a roughly 45 degree angle towards the tower portion. These views are illustrated in FIGS. 7C and 7D.

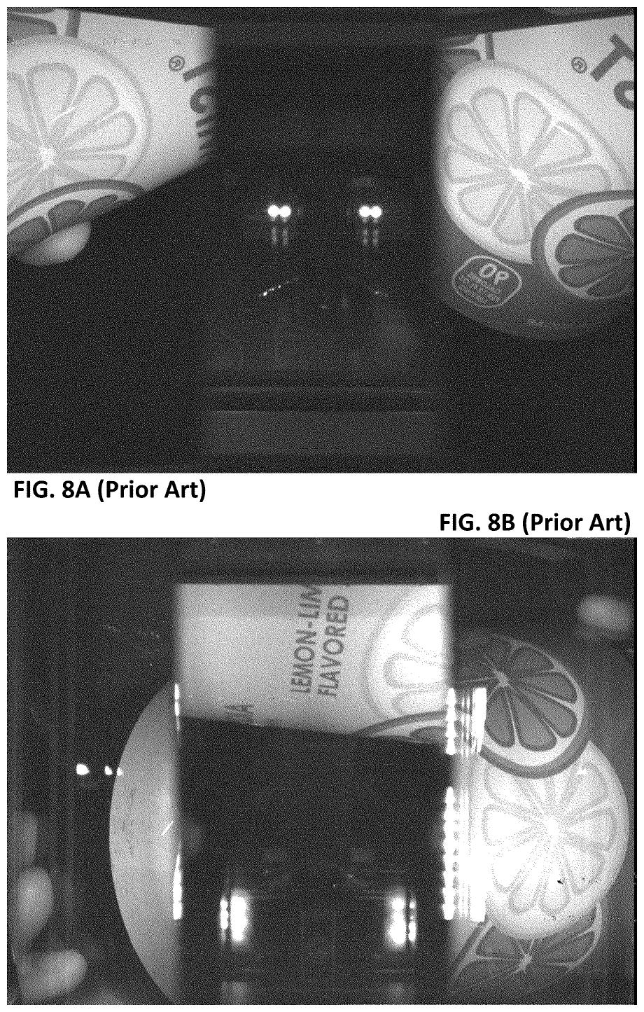

The projection of three different views onto a common image sensor in the tower portion, and the similar projection of three different views onto a common image sensor in the platen portion, yields composite imagery of the sort shown in FIGS. 8A and 8B, respectively. (The center facet of FIG. 8A is void of product imagery because the product (a two liter drink bottle) was positioned a sufficient distance away from the tower window that the downward-looking FIG. 8B view did not capture any of the product in its field of view.)

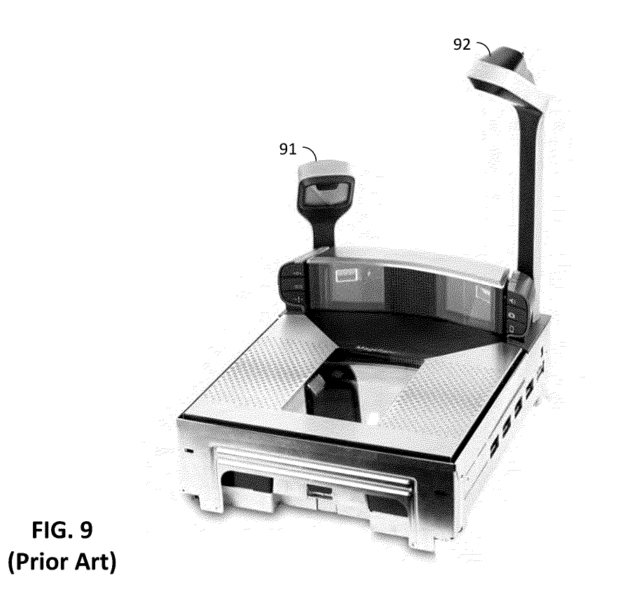

Another embodiment expands on the “bi-optic” configuration by use of one or more cameras that look down from further above, such as the cameras 91 and 92 in FIG. 9. (This figure illustrates the prior art Datalogic 9800i scanner with top down cameras.) Of course, many other, different, arrangements of cameras (and optionally light sources) can be used. As noted, one or more cameras may provide depth-sensing capability.

Camera image data depicting the checkout surface scene is sometimes compared against reference image data for that camera, depicting the surface when it is empty. Such reference image data can be captured once (e.g., when the camera is installed) and used thereafter. Alternatively, the reference imagery can be collected periodically, e.g., whenever the captured imagery is stationary for an extended period (e.g., five minutes). Such inactivity suggests the checkout surface is not being used, and is thus presumably empty.

In a variant embodiment, the camera field of view is divided into a multitude of rectangular (e.g., square) areas. For each area, a running sum of pixel data is accumulated as subsequent frames are captured, until a change is detected in that area. Accumulation is then reset (or paused) until frame-to-frame changes in the area subside. When the area has stabilized, accumulation of pixel data for that area begins anew (or resumes).

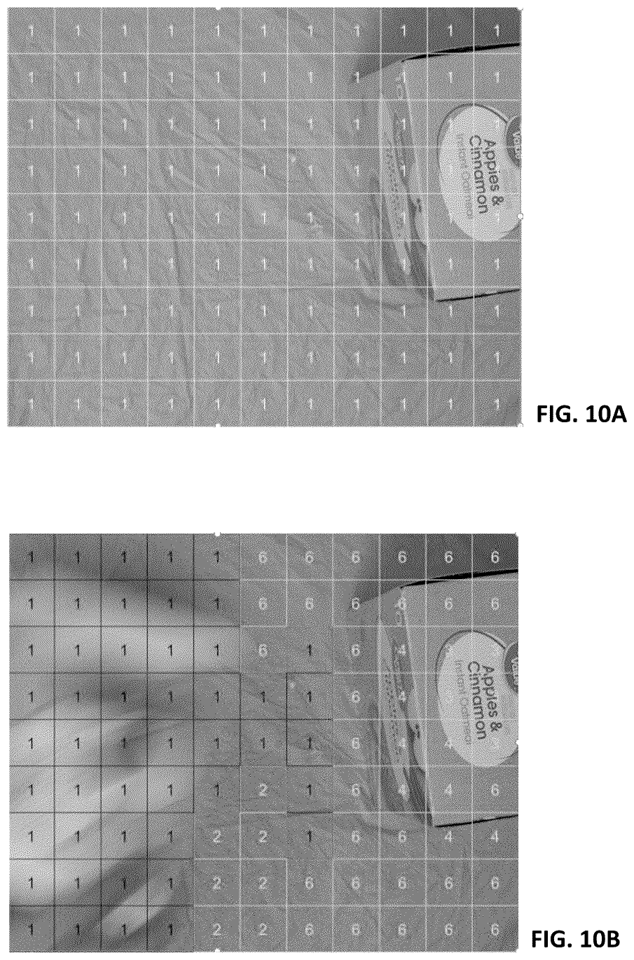

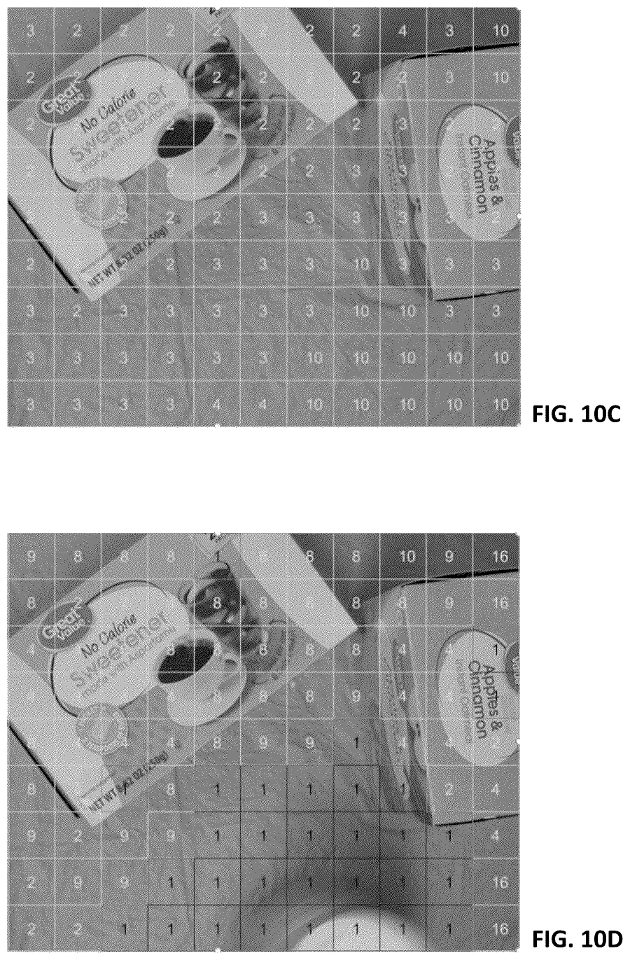

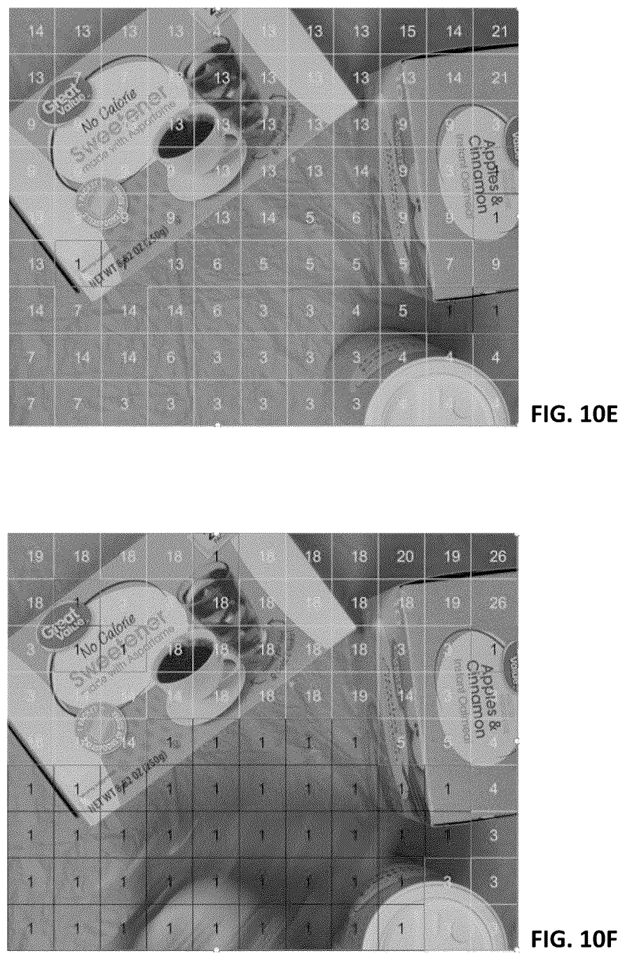

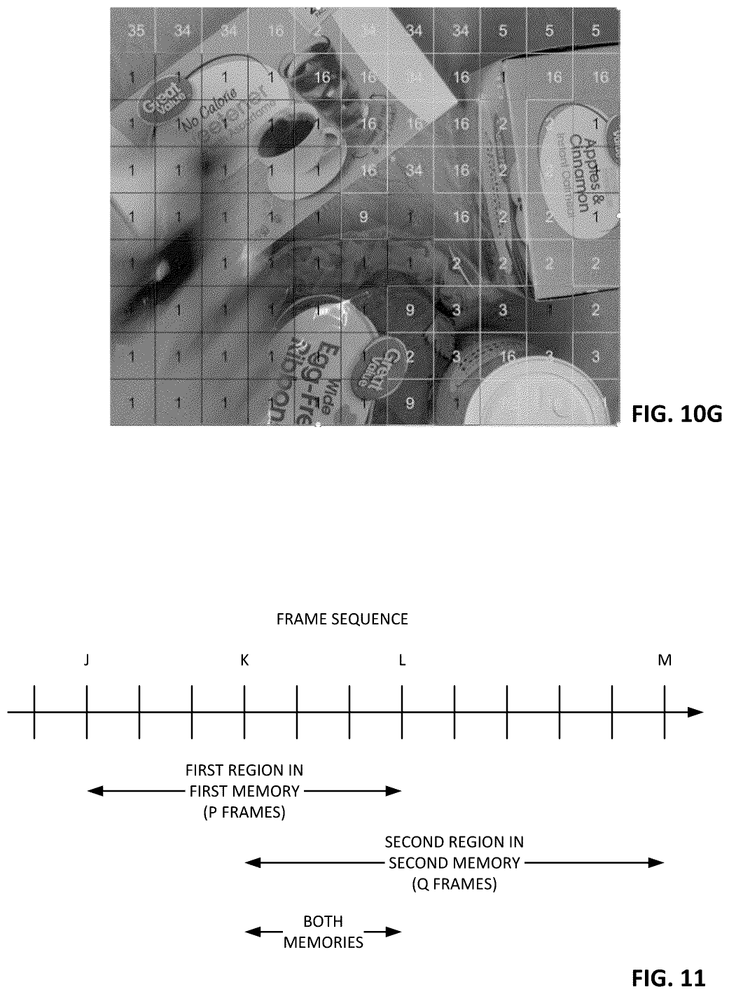

A particular embodiment is detailed with reference to FIGS. 10A-10G. In FIG. 10A, the system camera starts capturing image frames with an item (a box of instant oatmeal) already present on the checkout surface, in the camera's field of view. The checkout surface may be visibly textured, rather than uniform in appearance, so as to aid in detecting objects. (A neural network can be trained to detect image blocks where the checkout surface texture appears, permitting item identification processes to focus efforts on regions of interest in the imagery when the checkout surface texture is not detected.) The camera field of view is divided into square regions that are 320 pixels on a side. (A square region is not essential; regions of other shapes can alternatively be used.) The pixels from each square begin accumulating in a corresponding 320×320 buffer. (In some embodiments, downsampling by two, to 160×160, is used.) A count is maintained in memory of the number of frames that have successively contributed to each buffer. The overlaid “1” digit on each square indicates this count, indicating that each buffer has collected pixel data from one frame. (The overlaid count does not appear in the buffered image data; these numbers are overlaid in the drawings simply to aid explanation of system operation.)

FIG. 10B illustrates the situation several instants later, while a person's hand is moving a new item onto the checkout surface. (The hand and item are blurred in the illustration.) Pixel values in each square that depicts movement of the person's hand or the new item (or shadowing caused by the person's hand or the new item) changes with the movement. Such pixel changes exceed the threshold by which a changed square is distinguished from a static square. This change causes the buffers that accumulate pixel data for the changed squares to reset their accumulated data, and start anew in accumulating pixel data. Thus, the overlaid count in such squares indicates “1.” But in other squares, the imagery is not visually disturbed by the person/item movement, so the accumulation of pixel data in those buffers continues as before. In the upper right of the frame, for example, are squares whose buffers have accumulated pixel data for six frames—as indicated by the overlaid count “6.”

FIG. 10C shows the situation a few instants later. The scene has stabilized, and each square accumulates pixel data with each new frame. The squares that were visually-disturbed by the earlier movement have now accumulated pixel data from two or three frames of imagery (as shown by the overlaid “2” and “3” digits), while squares that haven't been disturbed since start of the process, e.g., at the top right, have now accumulated pixel data over 10 frames.

FIG. 10D shows a new item being introduced into the frame: a can at the lower edge. Disturbance of pixel values in this region of the frame causes accumulation of pixel data for squares in that region to reset, as indicated by the “1” digits overlying such squares. The disturbance exceeds the bounds of the can itself, due to shadowing that spans a larger area, thereby changing pixel values in many squares. But in the upper right square the pixel data accumulation continues as before, now including data from the past 16 image frames.

FIG. 10E shows the situation a few instants later, with the new can stationary in the lower right, and all squares adding pixel data to their respective buffers. The most recently-disturbed squares have accumulated just a few frames' worth of pixel data, while the long-undisturbed squares have now accumulated pixel data over 21 frames.

In FIG. 10F a new item is being introduced into the scene, causing pixel data accumulation to reset for many squares in the lower half of the frame. However, pixel data accumulates as before elsewhere, with some squares now having accumulated data over the past 26 frames.

FIG. 10G shows the situation some time later, with yet another item being introduced into the scene—causing accumulation of pixel values in affected squares to be reset. At some recently-passed time, a shadow disturbed pixel values in the upper right square, causing it to reset its previously-tallied accumulation and to begin anew. The overlaid count data indicates the buffer corresponding to this upper-right square has accumulated data from only the past five frames. At this moment, the square with the lengthiest accumulation of pixel data is in the upper left, which was reset by the action shown in FIG. 10B and has been accumulating image data since that time—now totaling 36 frames' worth.

As is evident from the foregoing, tallies of pixel data in buffers corresponding to different image regions accumulate and reset in accordance with changes in the scene. Regions that are visually static for longer get more benefit from averaging, reducing image noise.

Certain aspects of this embodiment is summarized in FIG. 11. A sequence of frames is shown, including frames J, K, L and M, in order (but not, here, consecutive). Data corresponding to values of a first set of pixels, depicting a first region of the scene, are accumulated in the span of frames J-L. (All frames in the span may be used, or only excerpted frames.) Data corresponding to values of a second set of pixels, depicting a second region of the scene, are accumulated in the span of frames K-M. Data may be accumulated from a count of P frames in the first memory, and a count of Q frames in the second memory. The Q frames include some, but not all, of the P frames. A composite frame is then produced using data stored in the first and second memories.

As detailed above, detection of a change in pixel values in the first region of a frame (here the L+1th frame) triggers discontinuing accumulation of data in the first memory as a consequence.

It will be recognized that data corresponding to values of the first set of pixels in frame J are among those averaged to establish pixel values in the first region of the composite frame, but not to establish pixel values in the second region of the composite frame. Similarly, data corresponding to values of the second set of pixels in frame M are among those averaged to establish pixel values in the second region of the composite frame, but not to establish pixel values in the first region of the composite frame. However, data corresponding to values of the first and second sets of pixels in frame K are among those averaged to establish pixel values in the first and second regions of the composite frame, respectively.

One embodiment includes a software application program interface (API) that, when called, performs a function that produces a motion-aware averaged frame. In one implementation, this function computes, for each buffer, an average value for each pixel within the corresponding square region. This is done by reading, from each buffer, the 320×320 (or 160×160) array of accumulated pixel values, and dividing each of these values by the associated count of frames over which pixel values have been accumulated. The resulting 320×320 (160×160) image regions (blocks) of averaged pixel values from all buffers are then assembled into a composite image frame. This image frame, composed of image blocks that commonly have been averaged over different intervals of frame accumulation, is then returned to the calling program as an output of the API.

In one embodiment, the camera captures frames at a rate of ten per second. A software program calls the just-noted API once each second (i.e., once every ten captured image frames) to obtain a composite image frame, comprising tiled square blocks of average pixel values. Because detected motion within a square block causes the corresponding buffer to reset, the averages of the different blocks may be computed over different numbers of frame captures. For example, average imagery for one block may be computed using imagery gathered in the corresponding buffer from ten frame captures, while average imagery for another block in the composite image frame may be computed using imagery gathered in its corresponding buffer from five frame captures. The composite image frame is then analyzed to identify items depicted in the frame. Such analysis can comprise barcode and digital watermark reading, and other techniques referenced in this specification.

In another embodiment, the above-described function to produce motion-aware averaged frames is implemented in an image processing pipeline, e.g., as hardware gates in silicon, sometimes on the same substrate as the sensor. The imaging sensor may capture frames at one rate, e.g., 60 frames per second. The image processing pipeline performs the above-described accumulation of pixel data in buffers. At intervals of every N camera frames, the processing pipeline produces an averaged square block of pixel imagery from each buffer, and assembles these blocks into a composite frame which is output as a motion-aware averaged frame. The interval N can be one, in which case a composite frame is assembled and output from the pipeline at the same 60 frame-per-second rate at which frames are captured by the sensor. If N is, for instance, 2, 3 or 6, then composite motion-aware averaged frames are output from the pipeline at a rate of 30, 20 or 10 frames per second. This is a form of video sequence, but is free of motion blur, and has varying degrees of suppression of imager noise, depending on how many camera frames were accumulated to produce each block. Such video can then be analyzed to identify objects depicted therein.

In still other embodiments, the API is not called on a recurring time- or frame-based interval, but rather is called on-demand, such as when an associated point-of-sale terminal has completed processing of a previously-produced composite frame and is ready to begin processing of a next composite frame.

In some embodiments, the blocks are not averaged by the corresponding frame count before assembly into a composite image frame. Instead, the accumulated data for each block can be assembled into a composite data structure. As noted earlier, the system that receives such output data can be designed to process information in this un-averaged form, e.g., by dividing accumulated pixel data in each block by the next-largest power of two. If the system that receives such output data is a neural network, it can be trained on training data of the un-averaged type.

It will be understood that a system configured to perform the above-detailed methods comprises a means for processing multiple frames of imagery captured by a camera sensor to produce an output image frame comprised of plural image blocks tiled together. A first of the blocks is produced based on pixel data from P captured frames, and second of the blocks is produced based on pixel data from Q captured frames, some but not all of the frames included in the Q frames are included in the P frames. Often P #Q.

Use of such motion-aware averaged imaging methods extends far beyond retail checkout. It can be particularly useful in low-light situations (where imager noise is a particular problem), and in neural network processing of imagery (where motion blue poses particular training challenges).

Another aspect of the technology concerns counting a number of items presented on the checkout surface.

When purchasing two instances of an identical item, e.g., two cans of cat food, it is important to the retailer that the two items not be mistaken for one, with a result that the consumer is under-charged. Similarly, it is important to the consumer (and the retail store) that the two items not be mistaken for three, with a result that the consumer is over-charged.

This task was simpler back in the era when each item was marked with only a single UPC barcode. Two cans of cat food included only two bar codes, so detection of three bar codes from an image frame did not occur. More recently, however, with the proliferation of products marked with tiled arrays of 2D digital watermark indicia, three or more codes may be decoded from different parts of an image frame, even when there is as few as one item depicted.

Even without digital watermarking, two cans of UPC-coded cat food might be tallied as one if the two items are presented at the same time, if the first can obscures visibility of the UPC code on the second.

In accordance with this aspect of the technology, imagery from multiple cameras is collected and analyzed to determine a count of objects on the checkout surface.

In one illustrative embodiment, two or more cameras view a checkout surface on which one or more items is present. The cameras are desirably oriented so that each views the checkout surface along a viewing axis that is non-parallel to the viewing axis of each of the other cameras. (In a conventional camera arrangement in which the camera lens is perpendicular to the image sensor, the viewing axis is regarded as the axis of the camera lens).

A first of the cameras captures a first image frame, which is compared with a corresponding reference image data depicting the same camera view but without any object on the checkout surface. As before, this comparison can be performed on a pixel basis, or on a patch basis. As before, this comparison may reveal certain areas in the captured first frame that match spatially-corresponding areas in the reference image (within an expected noise variation, as detailed earlier). Other regions may not match. These latter regions correspond to objects in the first camera's field of view that were not present in the reference image.

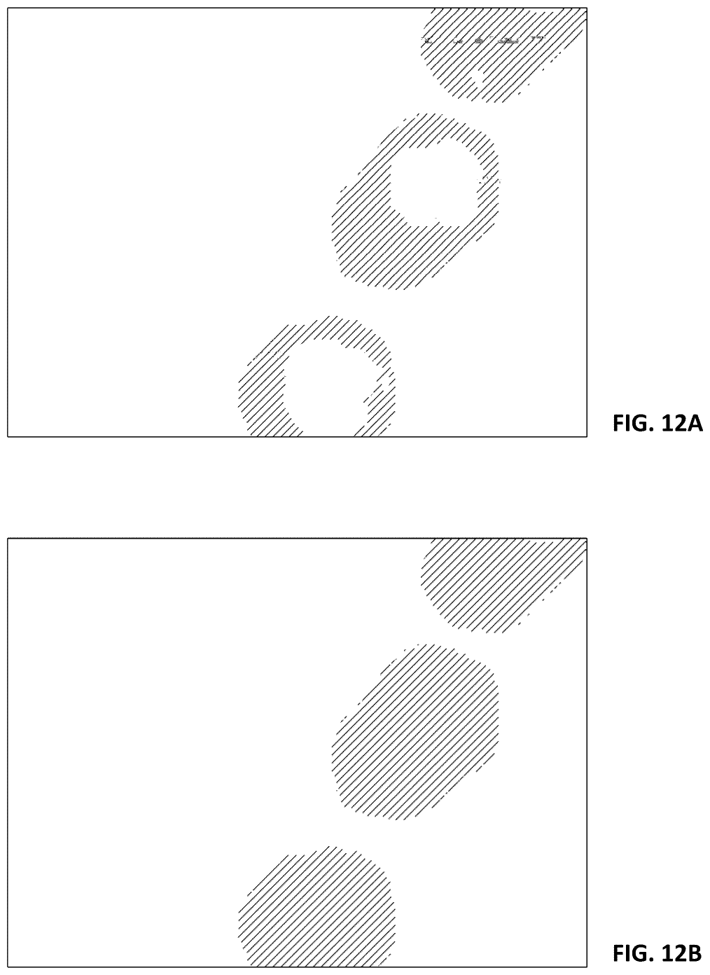

FIG. 12A shows an example. The white areas are where the captured image frame matches the reference frame. The cross-hatched areas are where the captured image frame does not match the reference frame, and thus depicts objects.

In this particular instance, the checkout surface is light-colored, and the objects are cans with shiny metallic tops and light colored regions in their artwork. In the captured first image, light reflected from the shiny metal top is bright enough that parts of the can tops (and part of the can artwork) is close enough in pixel value to corresponding parts of the reference image to be deemed to match the reference frame (i.e., their values are within the expected noise margin). This explains the included white areas within the hatched areas of FIG. 12A.

This imagery can be processed to identify white areas that are islands surrounded by hatched areas. In one embodiment, a connected components analysis is performed, from each of an array of regularly-spaced points across the image that are white, to see if they connect (by other white pixels) to the outer edge of the image frame. If they do not, then they are known to be islands of white surrounded by hatched areas, and such white points—and all white areas contiguous with them—are consequently changed to become hatched areas. (Here, as elsewhere, allowance is made for the permitted noise margin variability.) This image processing transforms the imagery of FIG. 12A into the imagery of FIG. 12B.

Contiguous object (hatched) regions in the imagery are next counted, and are here found to number three. This is the number of objects depicted, in disjoint arrangement, in the image frame. The hatched areas can also serve as regions of interest, which are analyzed by barcode- or watermark-detection methods (or otherwise) to identify the depicted objects. In contrast, the white areas can be ignored and not analyzed.

The just-described process is performed on imagery captured by each of the other cameras. Again, each is compared to reference imagery depicting that camera's view with the checkout surface empty. One or more regions of contiguous pixels are identified having values that differ (individually, or on a patch basis) from counterpart data in the reference image frame for that camera, within the expected noise margin. Again, such regions are counted, to thereby count the number of objects depicted in disjoint arrangement.

After imagery from plural cameras has been processed in this manner, the largest count obtained from any of the images is taken as a count of objects on the checkout surface.

As indicated, the challenge of obtaining an accurate count is most acute when two or more items presented for checkout are instances of a common object. That is, such items have identical Global Trade Item Numbers (GTINs). By processing multiple different views of the checkout surface in the manner described, captured by multiple differently-oriented cameras, a count of objects is achieved that can be used as a check against object counts determined otherwise, such as by a number of barcode (e.g., UPC) or watermark detections.

As noted, each of the images produced by comparison with the corresponding reference image (e.g., the images shown in FIGS. 12A and 12B) can serve as a mask that limits where object identification (e.g., by 2D code reading) is attempted. That is, such analysis is limited to pixel data within areas of the captured imagery corresponding to the cross-hatching in the processed imagery. Relatedly, code detection and other analysis is not attempted on pixel data in some or all of the areas of the captured imagery that do not correspond to the cross-hatched areas in the processed imagery, i.e., imagery that depicts just the reference image data taken when the checkout surface is empty.

The image comparison detailed above can be implemented using background subtraction techniques using the OpenCV2 image processing library. A tutorial, “How to Use Background Subtraction Methods,” from docs<dot>opencv<dot>org/3.4/d1/dc5/tutorial_background_subtraction.html, is attached as an appendix to U.S. priority patent application 63/435,188.

In other embodiments, the counting arrangement just-described can be used in conjunction with other object counting approaches. Such other approaches can employ trained neural networks, such as Mask R-CNN, following the teachings of He et al in their paper Mask R-CNN, Proc. of the IEEE International Conference on Computer Vision, pp. 2961-2969, 2017. (Mask R-CNN builds on Fast R-CNN, as detailed in Girshick, Fast R-CNN, Proc. of the IEEE International Conference on Computer Vision, pp. 1440-1448.) Faster-CNN can also be employed, as detailed in Ren, et al, Faster R-CNN: Towards Real-Time Object Detection with Region Proposal Networks, Advances in Neural Information Processing Systems 28, 2015.

Additionally or alternatively, such other approaches can employ depth sensing cameras. Depth information makes it possible to discriminate two objects that appear to overlap in conventional 2D imagery.

Such other counting arrangement(s) can generate independent counts. The largest of the counts is typically used.

In a particular embodiment, three or more cameras are used. OpenCV2 is used to open the cameras programmatically and establish data interfaces. Each writes each captured image frame to a frame buffer-part of a memory managed by a data broker software module. The scene on the checkout surface is analyzed in response to a call from a programming API. When this call is made, the most recent frame is obtained for each camera (e.g., from a buffer, or by calling the API discussed earlier to obtain a motion-aware averaged frame). Each frame is then compared with that camera's reference frame (depicting the camera view with no item on the surface), yielding a map like FIG. 12A (or like FIG. 12B if included regions are assigned to the surrounding object). Item recognition, such as by barcode and digital watermark reading (i.e., 2D code reading), is applied to each of the mapped (hatched) regions.

A data annotation module annotates resulting GTIN payloads with associated metadata, such as an identification of the camera image from which they were extracted, the location of a region within the image from which the payload was extracted, and a timestamp for the image capture.

A scene analysis software module performs object counting on the captured camera imagery, using one of the methods detailed herein, to obtain a check count of objects on the surface. Often, the count will match the number of different GTINs read from the scene. At other times, the count will be higher than the number of decoded GTINs. This likely indicates that there are several instances of a common object on the surface. In this case, the annotations are checked to identify a circumstance in which the same GTIN was decoded from two or more disjoint regions (e.g., as in FIG. 7) within a single image, indicating that this is the GTIN that should be tallied multiple times. (This is termed “count reconciliation.”) A data formatter module then outputs a list of GTINs and associated counts, in a consistent format (regardless of whether watermark or UPC-A or UPC-E, etc.) to a data consuming system, such as an associated point of sale system.

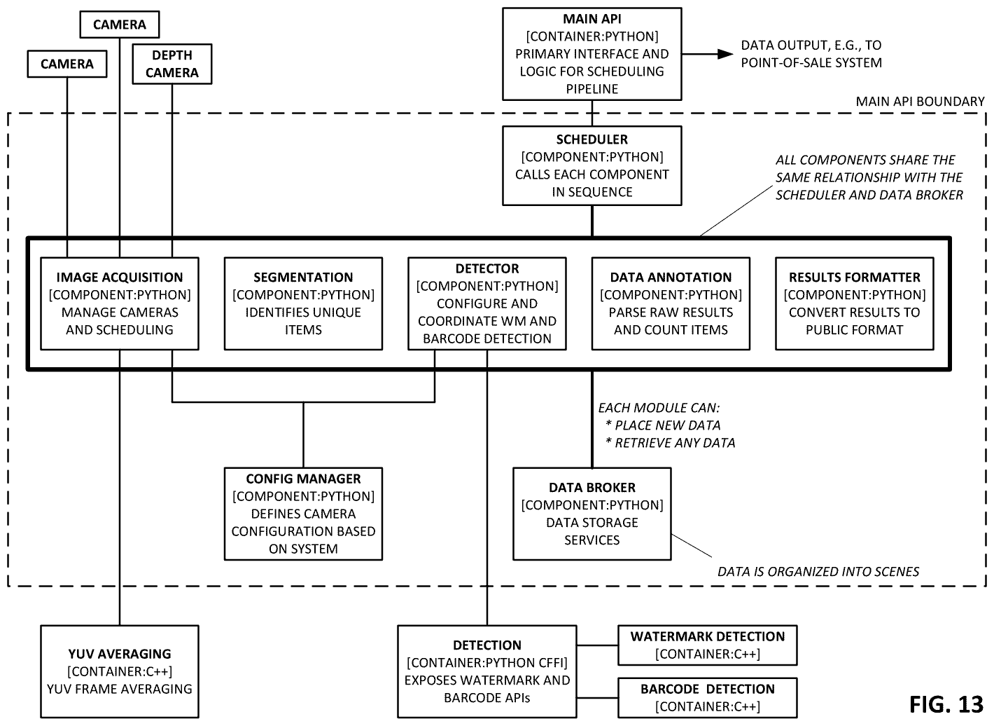

A block diagram of one such system is shown in FIG. 13. Illustrative cameras output YUV data—the luminance channel of which can be processed apart from the others for certain code reading.

To add further detail, the illustrated Data Broker serves to pipe all images and metadata through the pipeline modules (image acquisition, averaging, segmentation, watermark/barcode detection, annotation, and finally results formatting). The Scheduler orchestrates successive processing of data by the respective modules. Data is organized in “scenes,” a construct that is centered on a motion-aware averaged frame produced using free-running images from each camera, and typically shares the same frame dimensions and pixel coordinates as the camera-captured imagery.

The Detection module analyzes scene imagery and decodes any watermarks and barcodes encountered. Each decoded payload is associated with a spatial location within the scene (frame). In one embodiment, the watermark detection operation includes sparse, luma and chroma watermark detection. Additionally, barcode detection analyzes the scene imagery for UPC-A, UPC-E and EAN barcodes. (The arrangements detailed in U.S. Pat. No. 10,198,648 are used.) Payloads (e.g., GTINs) resulting from such reading operation are provided to the Data Broker for interim storage.

The Segmentation module performs the instance segmentation operations described below—parsing each scene into different regions (masks) corresponding to individual depicted objects. The Data Annotation module takes the decoded watermark and barcode payloads and, using their respective spatial locations, maps each to one of the segmented object masks, thereby associating each payload to a corresponding object. The Data Annotation module also performs in-scene de-duplication—assuring that a maximum of one decoded watermark payload and one decoded barcode payload is associated with each segmented object, discarding duplicates. If a watermark or barcode payload is decoded from a region of the scene outside all segmented object masks, it is retained—but only if it is not duplicative of a payload associated with a segmented object in that scene. The Results Formatter converts the decoded payloads as necessary to an expected format (e.g., GTIN-13), and expresses the information as JSON data for sending to a consumer of the data (e.g., a point-of-sale computer system).

In some implementations, the Detection module does not analyze all the scene imagery within a frame, but rather only analyzes excerpts falling within a segmented mask region. In either event, watermark or barcode analysis blocks can be spatially-distributed randomly through the imagery being analyzed-whether the complete frame, or just segmented excerpts.

The Scheduler invokes the foregoing operations in response to an API that used by an associated system, e.g., a point-of-sale computer system. The API has essentially three calls: StartSession, ScanScene, and EndSession.

The ScanScene function performs one pass through the depicted modules-using the most-current motion-aware averaged camera frame, and outputting a JSON with object mask information, and the watermark/barcode payloads (if any) associated with each mask. This function may be called on a periodic basis, such as once every second or two. Or it may be event driven, e.g., triggered by a change in weight sensed by a weight transducer under the checkout surface, or triggered by a motion detector. In a typical checkout scenario, the ScanScene function may be called dozens of times during a consumer's checkout session.

The StartSession function is invoked when a customer first interacts with the point-of-sale system, e.g., by touching a touchscreen. This function initializes variables and enables ScanScene functions to be performed, etc. The EndSession function is the complement-invoked after a customer has completed a transaction and has been issued a check-out receipt-clearing memories and preparing for the next StartSession call.

Desirably the operations depicted in FIG. 13 are multi-threaded, using a multi-core processor. For example, if there are four cameras, there are four threads that perform Image Acquisition—one dedicated to each camera. Similarly, there are four threads that perform the code reading—one dedicated to each camera and serving to process the corresponding image scene. The resulting JSON then conveys output information for four scenes.

Reference to an “API means” herein should be understood to refer to the just-detailed arrangement.

### Neural Network Techniques

Machine vision systems, based on trained convolutional neural networks, have made strides in recognizing objects from imagery. But certain difficulties remain. For example, it is difficult to reliably count a number of objects within a field of view when the objects are not disjoint. This is particularly so when multiple instances of the same object are present. Also, sometimes the association of a machine-readable indicia with one object, from among several clumped objects, is uncertain. Aspects of the present technology address these and other issues.

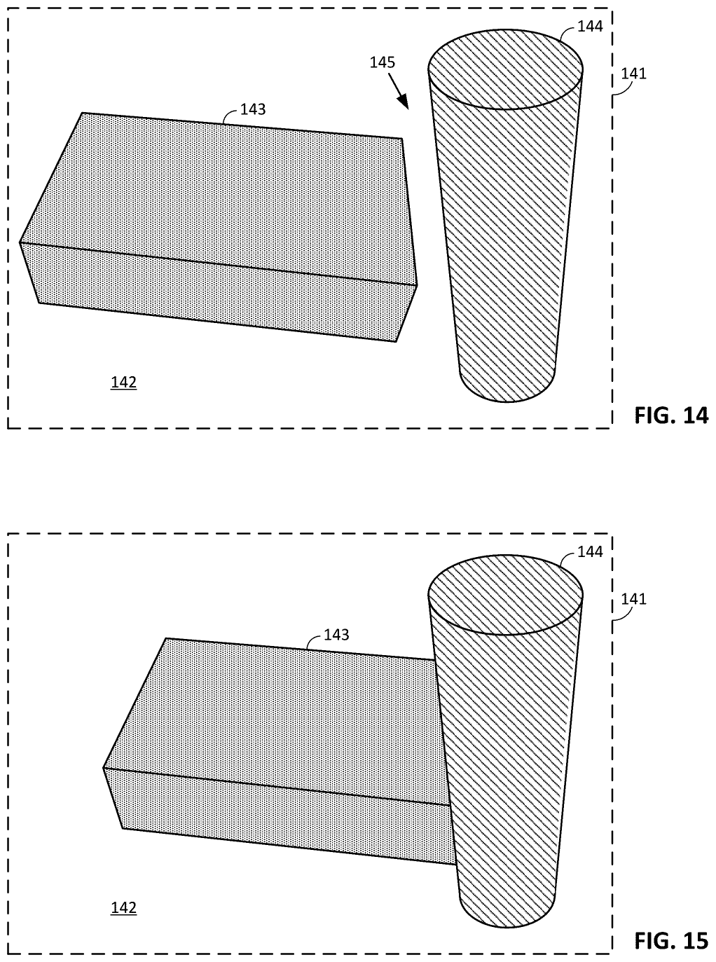

FIG. 14 shows a frame of imagery 141 captured by a camera (or obtained by the above-detailed motion-aware averaging techniques), depicting multiple objects positioned on a background surface 142. The objects may be, e.g., a box of cereal 143 and a can of potato chips 144. The objects in FIG. 14 are depicted as disjoint. That is, they are visibly distinct as viewed from the camera viewpoint. In this example, a pixel region 145 depicts the background behind the objects—visible through a gap that separates the two objects in this view.

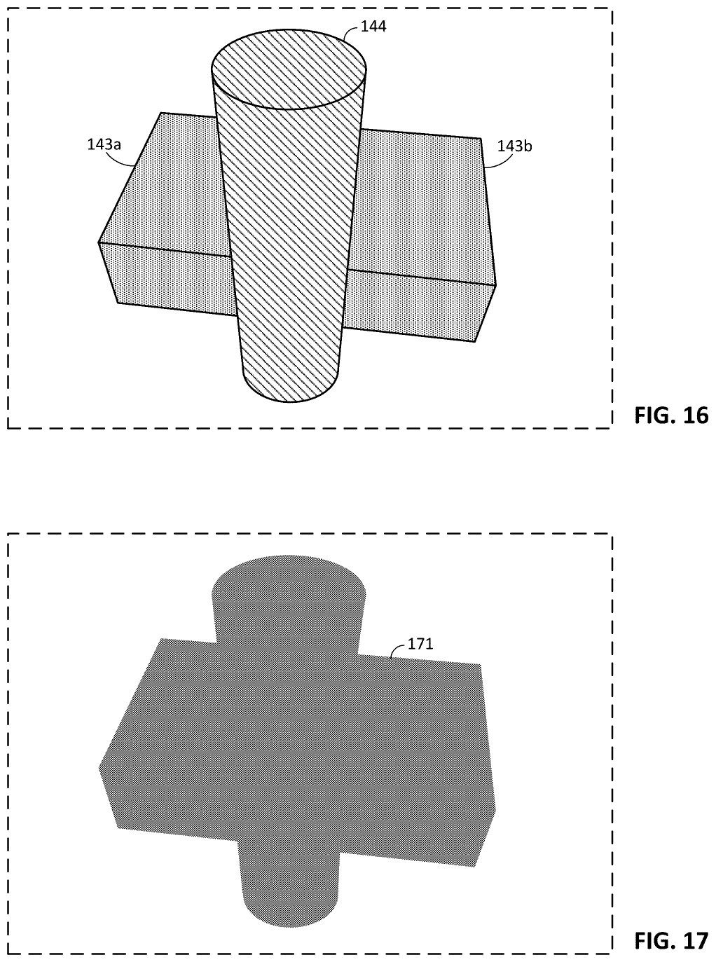

In contrast, FIG. 15 shows imagery with two objects that are not disjoint but rather are overlapping, or clumped. Part of the box is occluded by part of the cylindrical can. There is no depiction of a gap. Instead, pixels depicting the box immediately adjoin pixels depicting the can.

FIG. 16 shows another scenario. Here, too, the image depicts the two objects as overlapping, with the can occluding part of the box. In this instance, however, the box is depicted as two disjoint portions 143a and 143b, separated by pixels depicting the can 144.

To count items depicted in an image, one approach is to segment the objects. This can be done by performing a background differencing operation-subtracting a reference image of the same scene from the same viewpoint but without any objects, from the captured image. Pixel regions where the difference value exceeds a threshold indicate areas of the image where objects are present, while the remainder of the image is concluded to be background and can be ignored. A count of the regions then indicates a count of the objects. But this works only if the objects are depicted as disjoint.

If the objects overlap, this approach results in an undercount. FIG. 17 illustrates. It shows a segmented pixel region 171 identified by subtracting a reference image from the FIG. 16 image. Only one shape is segmented—the union of the pixels depicting the two overlapped objects. Instead of counting two objects, this method counts only one.

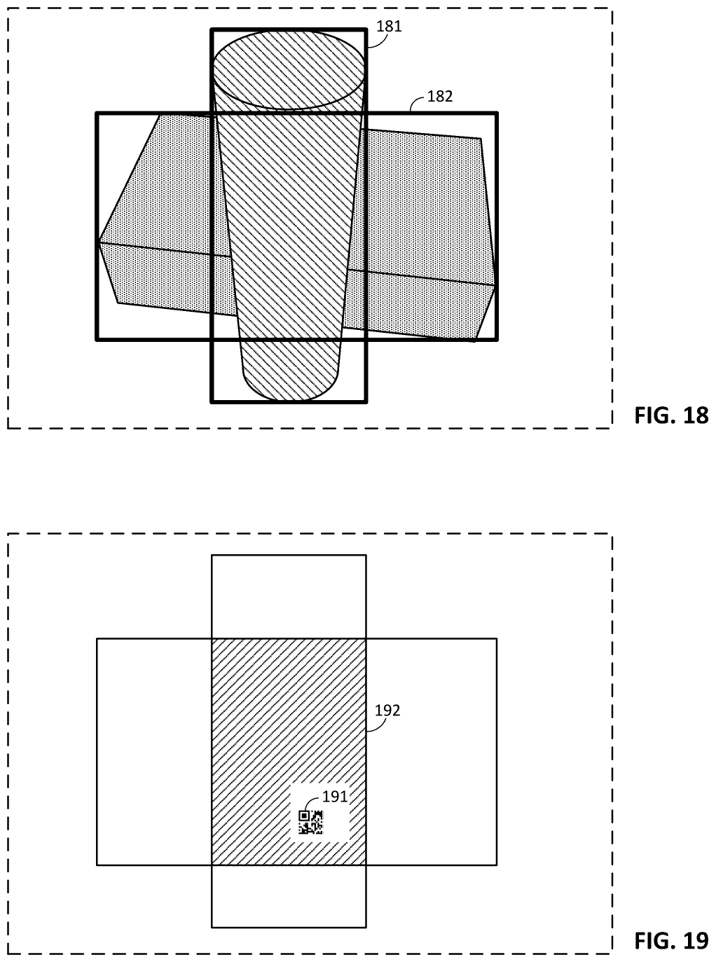

A second approach to object counting is to train a convolutional neural network to perform object detection. By such methods, a neural network can propose rectangular bounding boxes corresponding to different objects depicted in an image. FIG. 18 shows, in bold, two bounding boxes 181, 182, proposed by a neural network for the FIG. 16 image. The presence of two bounding boxes indicates a count of two objects.

While often satisfactory in counting objects, operation of the FIG. 18 neural network suffers a defect: the two bounding boxes do not indicate which one of the two objects occludes the other. This knowledge is important because sometimes information in the region of overlap (occlusion) needs to be associated with one item or the other. An example is a barcode that identifies one of the objects.

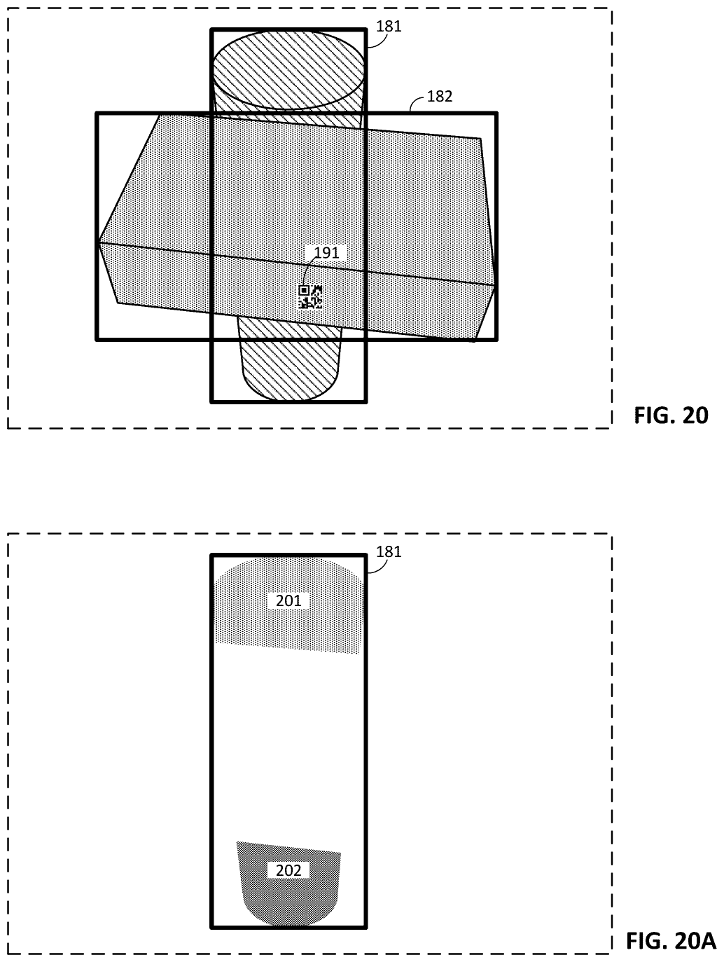

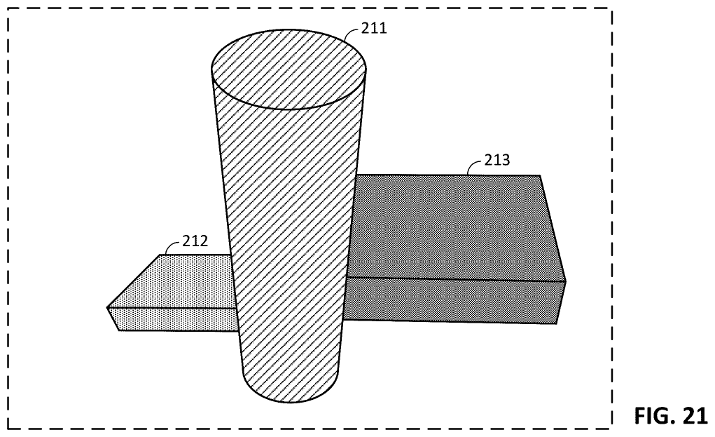

FIG. 19 illustrates, showing a barcode 191 in a region of overlap 192. Does the barcode identify the box or the can? The object detecting neural network does not indicate. While one may conclude the barcode belongs on the can, FIG. 20 shows an alternate reality. In FIG. 20 the box is in front and the can is behind, occluded. Yet the neural network produces the same bounding box output—again shown by bounding boxes 181 and 182. The barcode can plausibly form part of either object—the neural network provides no answer.

As is familiar, barcodes are widely used to track inventory. An example is in supermarkets and other retail establishments, where barcodes are sensed at checkout to provide information needed for stock replenishment. Such codes also serve to identify object metadata, including price, enabling retailers to compile checkout tallies for customers. (Barcodes typically don't literally include price and other metadata, but rather encode an identifier—commonly a Global Trade Identification Number, or GTIN—which is then used to access a database record containing metadata corresponding to the object.)

In accordance with one aspect of the present technology, applicant has discovered a method by which the front-most of two overlapping objects can be detected.

As is familiar, object detection by neural networks is a probabilistic exercise. Neither the identification of the objects (e.g., “can” and “box”), nor their bounding box locations, is certain. The operation by which the neural network proposes the identification and location data for each object also yields a confidence measure. To distinguish the front object from the back object, applicant has found these confidence measures provide guidance.

In particular, due to occlusion of the back object by the front object, the information available to the network about the back object is of lower quality than the information about the front object. This results in the confidence associated with the back object typically being less than the confidence associated with the front object. By noting which object is detected with the higher confidence, we can assign information from the overlap region to one object or the other, namely by assigning it to the object having the higher confidence.

Some networks have one or more layers configured for object (class) identification, and one or more other layers configured for bounding box proposals. Each object detector may thus be associated with two confidence scores: one score j for object classification and one score k for object localization. In such case, a metric M can be produced that combines both scores, e.g., by a polynomial equation of the form:

$$M = {Aj}^{X} + {Bk}^{Y}$$

where the coefficients A and B, and the exponents X and Y, are learned empirically for a given system by testing different combinations of these parameters against labeled imagery to discern which parameter set yields the most reliably-indicative metric.

While a neural network trained for object detection produces localization proposals in the form of bounding boxes, a network trained for object segmentation yields pixel-wise segmentation masks (maps)—each assigned to a corresponding object class. In such case, each pixel location may be reported to have a respective probability of being associated with the indicated object class. Such pixel probabilities can be used in the manner just-described to assess whether pixels depict part of a foreground object or part of an obstructed object.

An exemplary image segmentation system uses the Mask R-CNN technique, which includes one or more layers to identify bounding boxes (Regions of Interests, or ROIs) for probable objects (e.g., boxes 181 and 182 in FIG. 18), followed by one or more layers that perform mask regression operations to define pixel-wise object segmentations.

By use of the confidence score approach just-detailed, the front-most of two ROIs can be determined (ROI 182 in FIG. 20). This front-most object is then segmented first. Pixels corresponding to this front object segmentation mask can be set to black (or white), and segmentation can then be performed on the object(s) occluded by this front object (e.g., in ROI 181 of FIG. 20). In the case of FIG. 20, this operation yields two disjoint pixel masks 201 and 202, as shown in FIG. 20A.

In other embodiments, focus is used to assess which image region(s) depicts a foreground object and which depicts an obstructed object. Two cameras can image a common scene from proximate vantage points (or an identical vantage point if a beam-splitting arrangement is used). One camera can be set to have a nearby focus plane; the other can have a remote focus plane. By examining edges or local contrast in the imagery (e.g., black text on light backgrounds), e.g., with a Sobel or other edge filter, the focus at different regions of each image can be assessed, to determine whether an image region depicts an object that is closer to the nearby focus plane (and is thereby a foreground object) or closer to the remote focus plane (and is thereby a background object).

Image segmentation is sometimes used in film production to segment foreground items from the background. In such application there may be just one class-identifying the non-background objects, of whatever type.

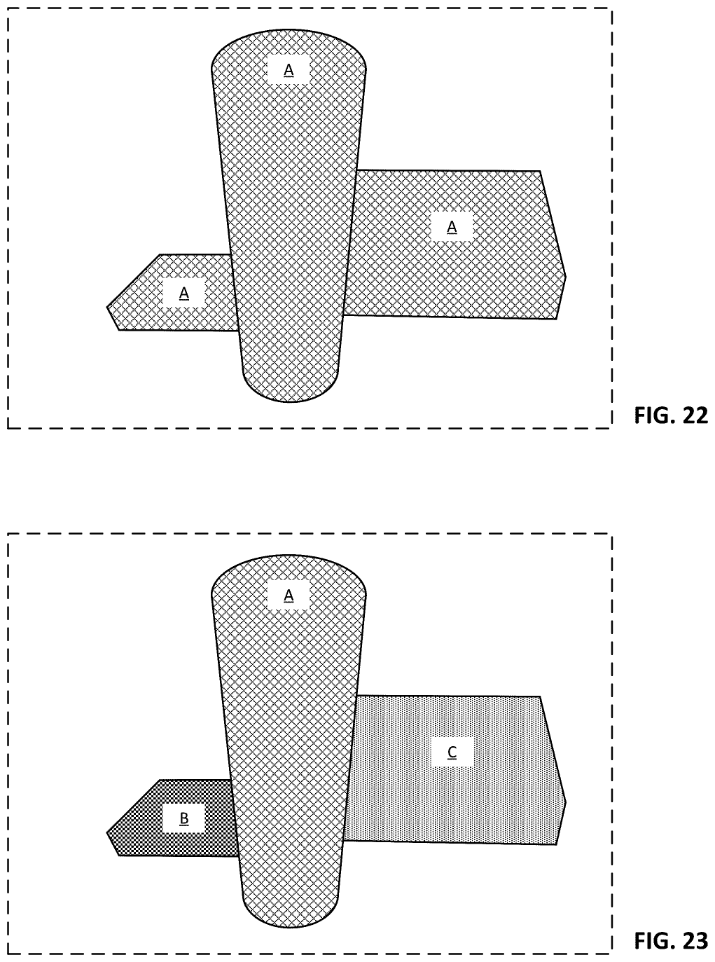

In object recognition applications, a single segmentation class may be assigned to all objects. Alternatively, different objects may be assigned to different respective classes. The image of FIG. 21, for example, depicts a tall cylindrical can 211, a small box 212 and a larger box 213. Pixel region masks corresponding to these different objects may be separately segmented into a common class, such as indicated by the identifier “A” in FIG. 22. Alternatively, these pixel regions may be segmented into three different classes, as indicated by the identifiers “A,” “B” and “C” in FIG. 23.

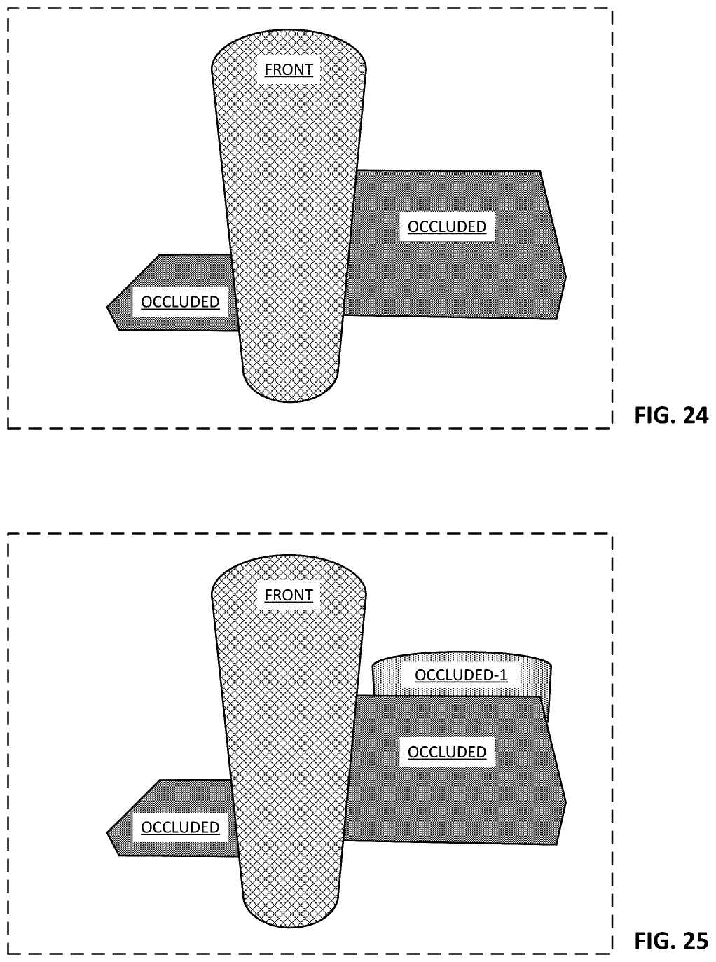

In accordance with an aspect of the present technology, a scene is not segmented with the objects assigned to a common class, nor with the objects assigned to different classes. Instead, the can is assigned to a Front class, and the two boxes are both assigned to an Occluded class. Such arrangement is shown in FIG. 24.

That is, classification in such arrangement is based on occlusion. If an object is not occluded by any object closer to the camera viewpoint, it is classified in the Front class. If an object is occluded by an object in the Front class, it is classified in the Occluded class.

If the scene includes one or more additional objects that are further back, partially occluded by an object of the Occluded class, it can be classified into a more remote Occluded class, e.g., Occluded-1. This is shown in FIG. 25 (in which the further object may be, e.g., a can of tuna, which is here occluded by the larger box).

Objects classified as Occluded necessarily involve uncertainty. Humans can sometimes sense visual clues that reduce the uncertainty. In FIG. 23, for example, a human can sense that the scene includes three objects. A neural network can be trained to produce the same conclusion (e.g., based on training images depicting three items, such as a can in front, and two occluded boxes behind, where the two occluded boxes reveal different height, width or depth dimensions, or where their edges—if extended through the occlusion—lack co-linearity).

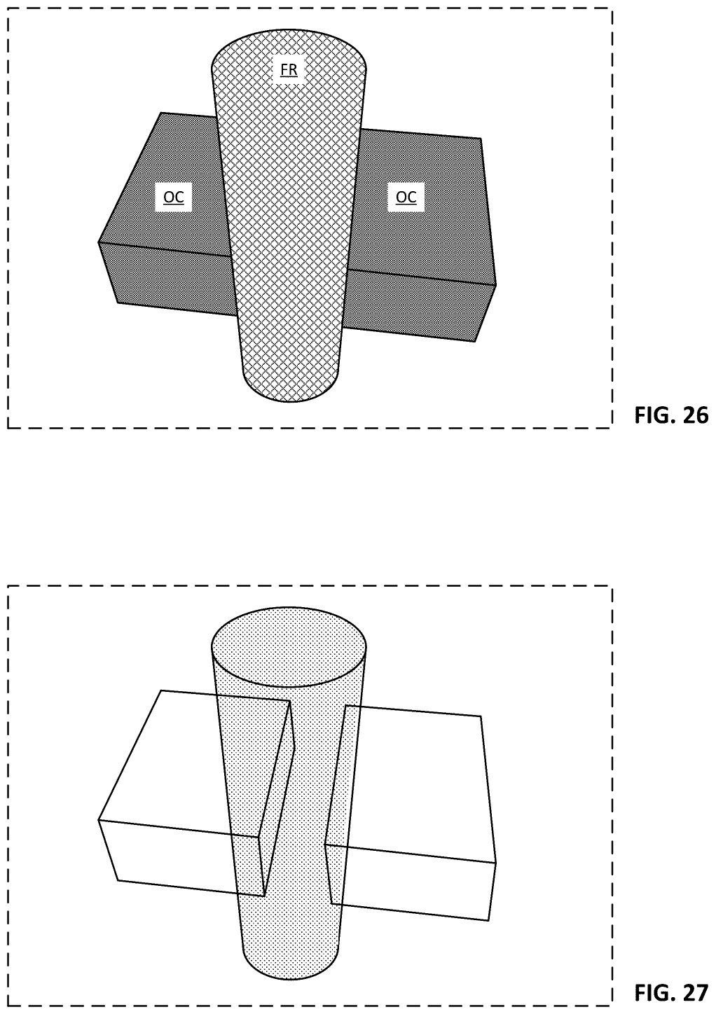

Sometimes humans get it wrong. Consider the image segmentation shown in FIG. 26, with the Front classification denoted as “FR” and the Occluded classification denoted as “OC.” Visual clues suggest there are two items: a box occluded by a can. But as shown by FIG. 27, the reality can be different: there may be two boxes and a can.

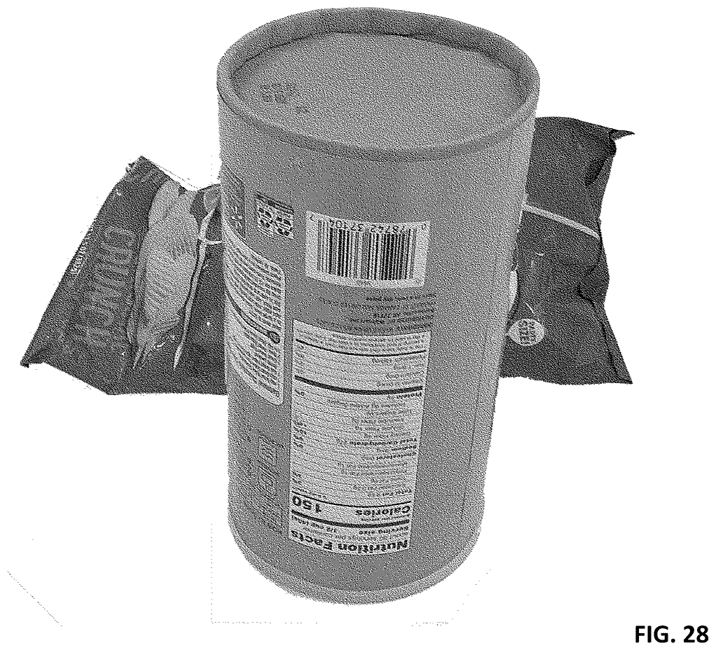

FIG. 27 is contrived and not likely to be found in the real world. But other such uncertain situations arise commonly, e.g., involving irregularly-shaped objects, like bags of frozen berries, dried beans, snack chips and the like. FIG. 28 gives an example, showing a can that occludes one or more irregular snack bag packages.

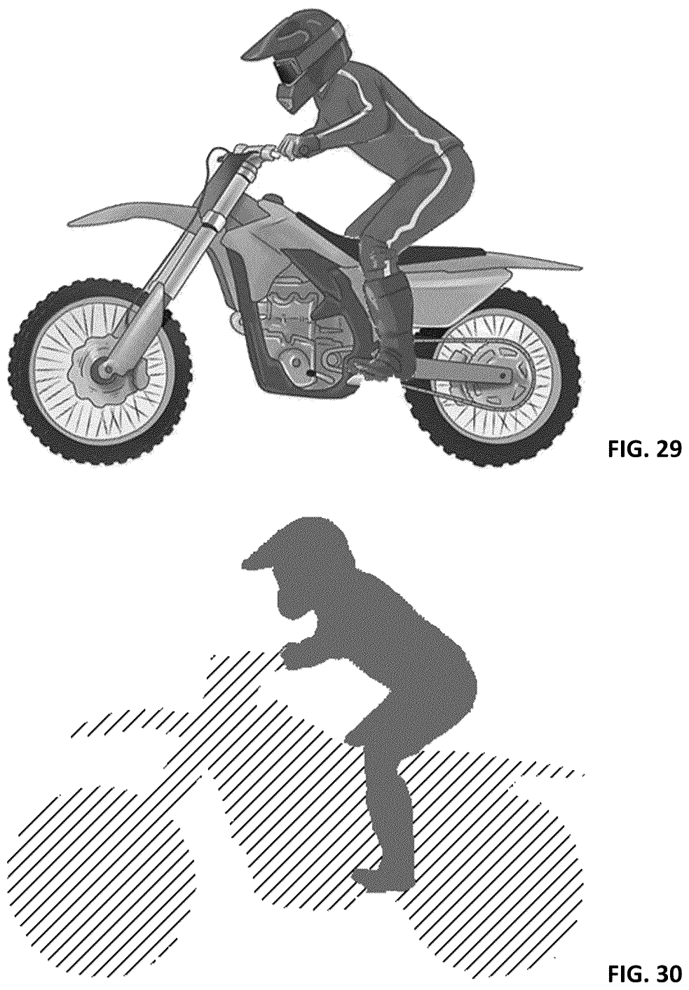

In many applications, situations like that shown in FIG. 27 or 28 do not arise or are not a concern. As an example, consider the image of FIG. 29, in which a rider occludes part of a motorcycle. This image can be segmented into two classes (not three) with high certainty, despite the fact that the motorcycle is depicted as two disjoint pixel regions (as shown by the segmentation of FIG. 30). The uncertainty introduced by the occlusion is not large enough to permit the possibility that there may be two different motorcycles in the scene.

In supermarket checkouts, however, significant uncertainties due to occlusion commonly arise and they have important consequences. An item mis-count due to such uncertainty can lead to a customer being charged too much, or a retailer collecting too little.

How to deal with the uncertainty, e.g., of FIG. 28? One approach is to employ object self-identification, by encoded payload data. As noted in certain of the patent documents incorporated-by-reference, retail packaging commonly includes UPC barcodes, and increasingly also includes Digimarc brand digital watermarks. Both are machine-readable codes that convey multi-symbol payload data. If occluded objects on two sides of a front object are found to have different payloads, they can be understood to be not different parts of a single object, but rather two different objects.

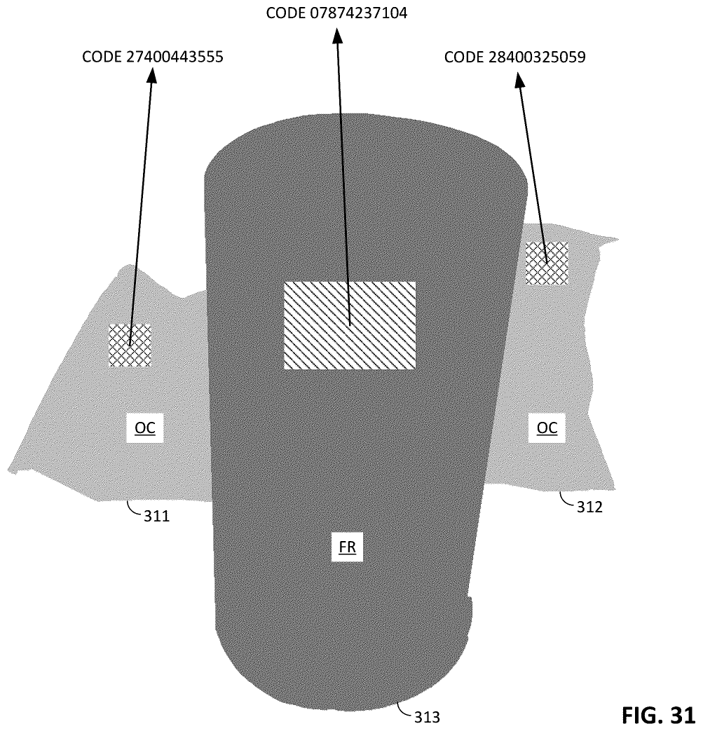

This is shown in FIG. 31, in which the image of FIG. 28 has been segmented into regions assigned to Foreground and Occluded classes. Different watermark payloads (codes) are extracted from the two disjoint Occluded object regions 311, 312, and a UPC barcode payload is extracted from the Front object region 313. (The Front object may be counted even without decoded payload data, since its segmentation classification as a Front object indicates low uncertainty.) In this instance, the scene is thus understood to include three objects, not just two. It may include more than three objects, but it does not include less.

If codes for object self-identification cannot be discerned from surfaces of occluded objects depicted in an image, then resort can be made to other methods of dealing with the occlusion uncertainty in object counting.

One method uses color histogram data to decide whether the two occluded regions 311, 312 are different parts of a single object, or are two different objects. In one illustrative embodiment, a first color histogram is generated from pixels in region 311 (i.e., pixels corresponding to one segmentation mask), and a second color histogram is generated from pixels in region 312. (If region 311 is part of a Lays potato chip bag, and region 312 is part of a Doritos chip bag, yellow pixels will dominate the former, while red pixels will dominate the latter.) A database search is then conducted to identify items stocked by the store that have artwork consistent with the first color histogram. A first set of candidate matches for the first region is thereby generated. A second database search is conducted to identify items stocked by the store that have artwork consistent with the second color histogram. A set of candidate matches for the second region is thereby generated. The two sets of candidate matches are examined for overlap. If no candidate item in the first set is found in the second set, then the two regions 311, 312 can be concluded to depict two different products.

Another method uses image fingerprinting to decide whether the two occluded regions 311, 312 are different parts of a single object, or are two different objects. In one illustrative embodiment, image data from the first region 311 is analyzed to extract SIFT keypoint data. This data is checked with a reference database containing SIFT keypoint data for products stocked by the store. A first set of one or more products in the database may be found to have keypoint data consistent with (i.e., matching) the keypoint data extracted from region 311. (Multiple products may match due to the small sample of imagery available from region 311. If the region depicts, e.g., a Frito Lay logo, multiple products in the database that are marked with the Frito Lay logo may be identified as matches.) The same analysis is performed using image data from the second region 312, and a second set of one or more matching products may similarly be identified. If both analyses yield database matches, but there is no product in common between the first and second set of matches, then the two regions can be concluded to depict two different products.

Still another method uses text recognition to decide whether the two occluded regions 311, 312 are different parts of a single object, or are two different objects. In one illustrative embodiment, image data from the first region 311 is analyzed to extract any visible text data. A search is made of a database that includes text found on each product in the store inventory, to identify a first list of candidate object identifications. Image data from the second region 312 is similarly analyzed, and checked against the database, to identify a second list of candidate object identifications. Again, if no item in the first list is found in the second list, then the two regions can be concluded to depict two different products.

The database searches noted above can be made more useful if they can be limited to just a segment of the inventory. One useful segmentation is by class of container shape, e.g., cylinder, box, bag, or other. A neural network classifier can assess each of image regions 311, 312 to classify it as to container shape, to thereby determine which of the database segments should be searched. If region 311 and 312 are both found to be in the bag class, then database records for Campbell's soup cans need not be considered.

In some embodiments, such a classifier provides an estimated probability for each of the possible container shape classes. For example, the classifier may conclude region 311 has a 92% likelihood of being a bag, a 6% likelihood of being “other,” a 1.5% likelihood of being a can, and a 0.5% likelihood of being a box. These probabilities can be mathematically combined with, e.g., histogram or fingerprint match probabilities, to weight the latter. Only candidate item matches from the database having a weighted probability above a threshold value (e.g., 5%) may be considered further.

If such a classifier concludes that the two image regions 311, 312, depict different container shapes (e.g., by respective probability scores being above a threshold), then that strongly indicates the two regions depict two different products.

Still further, the image region 311 can be provided to a neural network that has been trained to recognize items stocked by the store, based on image excerpts. The network provides a list of candidate item identifications, each with a probability score. The same operation can be performed using image region 312. The two lists of candidate item identifications, with respective probabilities, can be checked to determine whether commonality of the products depicted by the two regions can be ruled out. For example, region 311 may be identified by the neural network as most-likely a Lays potato chip bag, with a 90% probability. Region 312 may be identified by the network as most-likely a Doritos chip bag, with a 75% probability. The probability of the first region depicting a Doritos bag may be 0.3%, and the probability of the second region depicting a Lays bag may be 0.1%. These metrics can be combined, e.g., using a polynomial equation of the sort detailed above (extended for four variables) to yield a net score, which can be compared against a threshold to determine if the two regions can be concluded to depict two different products.

Again, if the container shapes depicted by regions 311 and 312 are classified by a first neural network (i.e., classified as a bag, can, box or other), then a second neural network that has been trained to recognize items by appearance can rule-out items that are other than the determined classes, in proposing identifications for segmented imagery 311, 312.

The above-noted techniques for discriminating whether two disjoint, occluded pixel regions depict different parts of a single object, or depict parts of two objects, can be used together. For example, if the text “Nacho” is extracted from region 311, the text database can be searched to identify a list of products having that term on the artwork. As to region 312, a histogram database can be searched for histogram data derived from region 312 to identify a list of products having coloration consistent from the derived histogram. These two lists of products can be compared to determine if there is any overlap. If there is no overlap, then regions 311, 312 can be concluded to depict parts of two objects, not one.

If there is no overlap between two lists in any of the foregoing arrangements, the two regions are concluded to depict two objects. But if overlap is present, we can't conclude that only one object is present (nor that two objects are present).

Further checks can be made to try and resolve this ambiguity. One type of further check scrutinizes just one of the two pixel regions, to try to limit its possible identification. For example, instead of just a histogram analysis, the pixel region 311 might also be analyzed based on detected text, as described earlier. A list of candidate identifications consistent with histogram can be compared to a list of candidate identification consistent with text detection to narrow possible identifications just for region 311, i.e., identifying only those products consistent with both types of data. This narrowed list of candidate identifications for region 311 can be compared with a list of candidate identifications for region 312 generated by histogram alone, or by fingerprint keypoint data alone. If there is no overlap, the regions can be concluded to depict two objects.

Alternatively, a list of candidate identifications for region 312 can be narrowed on the basis of several criteria, just as candidate identifications for regions 311 can be so-limited. As candidate identifications for each pixel regions are narrowed, the possibility of overlap between regions 311 and 312 due to chance is reduced. If candidate identifications for the two pixel regions are ultimately found not to overlap, then regions 311 and 312 can be concluded to depict two objects not one.

It will be recognized that the above-noted attributes are exemplary rather than limiting. Other attributes can similarly be used. (One example is barcode or other machine-readable data, e.g., sensed from the pixels of region 311.)

In the foregoing arrangements, instead of checking database information to identify products consistent with a particular attribute (such as histogram data or extracted text), reference may instead be made to a database or other information source to determine products inconsistent with a particular attribute. In one such arrangement, a list of overlapping candidate identifications is generated as described above. Some or all of these candidate identifications are further vetted for inconsistencies. For example, if one of the overlapping candidate identifications is a five pound bag of Gold Medal flour, yet a weigh scale in the checkout surface indicates the aggregate weight of all items on the surface is two pounds, then the bag of Gold Medal flour can be removed from the overlapping list of candidates. Again, if the overlapping possibilities can be reduced to zero, then image regions 311 and 312 are known to depict two objects, not one.

If analysis of the available data is unable to conclude that the image regions 311 and 312 depict two objects, then such regions may depict one object or two. This uncertainty may be resolved by use of other sensor data, such as a second image depicting the scene (or a part thereof) from a different viewpoint, e.g., captured by a second camera.

If the first and second images are captured from fixed cameras, then each pixel in the first image can be projected to form a line in 3D space (i.e., the ray from the camera lens to the object point depicted by that pixel in the first image). That line in 3D space, in turn, corresponds to a line of pixels in the second image. The object point in the first image will be depicted somewhere along that line of pixels in that second image-assuming the object point is visible from the second viewpoint and is not occluded. This technique is sometimes termed Shape from Silhouette.

Such relationships are expressed mathematically by a homography between the two views, which can be derived from parameters of the lenses and coordinates of the cameras, or can be determined empirically. Either way, the homography establishes correspondence between object regions 311 and 312 in FIG. 31, and counterpart object regions in an image captured from a different viewpoint. This knowledge of object correspondence allows extraction of more information about the object of which depicted region 311 forms part, and about the object of which depicted region 312 forms part.

In some cases, where the viewpoints are sufficiently different, the occlusion that gave rise to the uncertainty about regions 311 and 312 in FIG. 31 will be absent in the second view, allowing unambiguous determination of whether such regions depict two objects or one, using techniques described, e.g., above.

Even if the occluding obstruction 313 is still depicted in second image (or a different obstruction is present in the second viewpoint), and still occludes the same object(s), the object(s) will be depicted differently in the second image, perhaps revealing different information that can be used by the foregoing techniques to establish that there are two objects, not one. For example, pixel-wise segmentation of the second image may define a region in the second image that encompasses an area known to correspond, by homography, with region 311 of the first image, and depict additional object surface area as well. This larger depiction of part of an object can allow for collection of additional information, e.g., text or keypoint data, that allows further narrowing of a list of candidate identifications for that object. This narrowing, in turn, may lead to a winnowing, to zero, of the number of possible item identifications that are in common for regions 311, 312, which in turn indicates there must be two objects present.

Sometimes the second image depicts, without occlusion, an object of which region 311 is recognized (by the homography) to form part, while still depicting, in occluded fashion, the object of which region 312 is recognized to form part. In this case, it is known there is not one object but two. But the continuing occlusion of the second object still permits the possibility that one or more other objects is present, with their view blocked by the same obstruction.

Naturally, situations can arise in which an object is fully occluded from many cameras, such as when a soup can is surrounded by several cereal boxes. In such cases, one or more cameras that view the scene from overhead or beneath can be useful. But even with such cameras, a soup can might be fully concealed, e.g., by an enclosure formed of cereal boxes. In such cases, data from a weigh scale is useful in discerning that more is present than can be seen, and to summon a clerk to the checkout station for assistance.

As indicated, resolution of uncertainty about item count is made more difficult if the two image regions depict two objects, but the two objects are different instances of a common object. For example, each of regions 311 and 312 may depict different bags of Lays Classic potato chips. In such case, each of the tests involving region 311 may indicate the possibility that this region depicts a Lays Classic potato chip bag, and likewise for region 312. Yet such information is inconclusive about whether there is one object or two. (This information is even inconclusive about whether either item is a Lays Classic potato chip bag or something else-even if this is the only candidate identification determined for each image region.)

Digital watermarking on the objects can be useful in such circumstances. Sometimes, two instances of the same object can be encoded with different payload data, e.g., to include lot information, expiration data, or data serializing unique instances of the object. If different payload data is detected from image regions 311 and 312, the system concludes there are two objects present, not one.

Even when two instances of the same object are encoded with identical payload data, the watermark signal can still reveal that there are two objects instead of one. This is due to the presence of a geometric synchronization signal in certain watermarks, including those of Digimarc Corp. In the Digimarc watermark decoder, this synchronization signal is used to establish a spatial frame of reference to identify image locations from which to sample bits of information for payload decoding. This frame of reference indicates a “north” (aka “up” or “top”) direction for each watermark block, and packaging artwork typically comprises multiple blocks-all tiled with a common orientation. If each watermark block comprises a 128 row by 128 column array of encoding locations, with locations numbered sequentially in raster fashion starting from the top left corner, then the north-south axis is defined by the directions of the columns, and north is towards the first row in the array.

Package artwork is commonly encoded so that the “north” direction of watermark blocks is towards the top of the package. Boxes and many other containers are typically made by folding and gluing (or heat-sealing) a sheet of printed substrate. Although the containers are not absolutely rigid, they cannot be freely distorted. Thus, the range of variation that is possible among different watermark blocks on packaging artwork is limited.

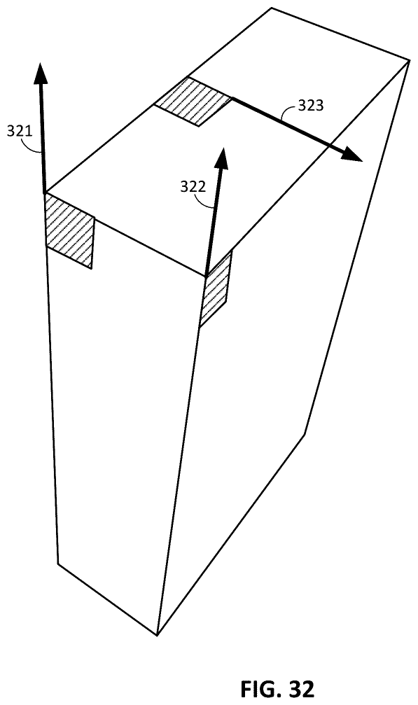

If the front face of a cereal box is depicted in an image so that “north” in one watermark block points up and to the left, then all blocks in the image that depict this same face of that box will be depicted with similar orientation. On boxes and other cardboard substrates, no variation in watermark orientation is expected among blocks on a common face, although perspective distortion can cause some slight differences. The range of expected differences for such cardboard-packaged objects can be empirically determined. Once such a range is established, it can serve as a threshold test. If two watermark blocks are depicted in an image and found to have orientations that differ by more than this threshold amount, and they identify (e.g., by metadata associated with the decoded watermark payload) an object that is packaged in a cardboard container, then either the blocks are found on different instances of the object, or are found on two different panels of a single object instance-one of them being a top or bottom panel. (See FIG. 32. The orientation of watermark blocks on front, rear and side panels of a carton all share a common “north” direction, e.g., as shown by arrows 321 and 322, but the “north” orientation can be different for blocks on the top and bottom panels, as shown by arrow 323.)

A neural network can be trained to predict (classify) whether imagery depicts two identical items bearing the same digital watermark, or a single item, based on reports of watermark signal detection at different locations in the image, the synchronization signal, and the watermark payload itself. Nearby detections from a single item will not normally have much variation in watermark orientation, whereas more remote detections from a single item can be expected to have progressively more orientation variation. The degree of variability will be greater for watermarks detected from flexible packaging, such as a bag of frozen shrimp, than from relatively rigid packaging, such as a box or can. With sufficient labeled examples, a network can learn what degree of orientation variability occurs in different contexts with different items, and can render predictions on new data accordingly.

Such a network can similarly be trained, using labeled example images, to employ the scale and translation parameters detected from image watermark signals to discern whether multiple watermark signal detections indicate multiple items, or a single item.

As noted, neural networks can also be trained to perform pixel-wise segmentation of objects in imagery. Training involves presenting the network with large numbers of training images accompanied by associated ground-truth segmentation information. The ground-truth in the training images is typically provided by human reviewers. That is, images of checkout scenes, each depicting one or several items, are captured and presented to a human to annotate. The human employs a stylus, or mouse, to define a polygonal border outlining each different item in the image. The border establishes the ground-truth for the item—the area of pixels that should be labeled as depicting the item. The shape of the border matches the visible shape of the item. A vector description of the border is written as metadata accompanying the image. This description can define lines comprising the outline, e.g., stored as pairs of {x,y} coordinates defining the endpoints of each line. (Descriptions otherwise, such as by curves and splines can be used instead.) An identification of each outlined item can also be stored as image metadata, e.g., defining the item by its product name, by GTIN, or simply as a Foreground item (e.g., F), or as an item Obstructed by a Foreground item (e.g., O), or as an item obstructed by an Obstructed item (e.g., O1), etc.

When training a network to perform pixel-wise segmentation, a commonly-used performance metric (e.g., as a mask loss function) is Intersection Over Union (IOU). This metric is the ratio of two areas. The first area is the intersection between the human-annotated (ground-truth) area of an item, i.e., the region within both the human-added boundary, and the network-predicted area of the item (the so-called predicted mask). The second area is the union of these two areas.

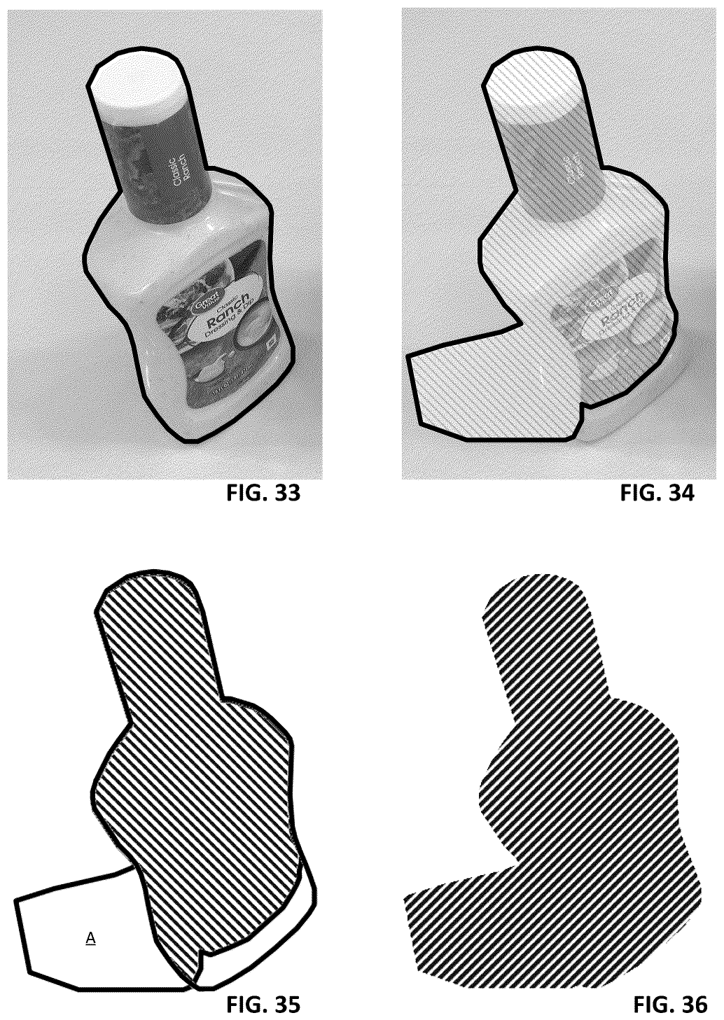

Consider FIG. 33, which shows a scene with a salad dressing bottle, annotated with a human-defined outline defining its ground-truth area. FIG. 34 shows the same image scene as it might be segmented by a network. In some respects, the predicted mask of FIG. 34 is over-inclusive (i.e., encompassing a shadowed region to the lower left), while in other respects it is under-inclusive (i.e., missing the bottom and lower right corner of the bottle). The intersection of the two areas (i.e., the area they both share in common) is shown by the cross-hatched area of FIG. 35. The union of the two areas is shown by the cross-hatched area of FIG. 36. The IOU metric is the ratio of the former area to the latter area, and necessarily is one or less. During training of a neural network, IOU is used as a performance metric that is sought to be maximized, by iteratively adjusting the network coefficients.

(Some network training procedures operate by minimizing an error metric rather than maximizing a performance metric. Gradient descent training methods are of this type. In such case, the IOU metric can be inverted, into union over intersection. That is, the area of FIG. 36 can be divided by the cross-hatched area of FIG. 35 to produce an error metric greater than one, which can be iteratively minimized towards one by training. Another such error metric is the difference between the IOU metric and the value one, i.e., (1.0-IOU). Many other variants can be used. For expository convenience, all may be regarded as IOU functions.)

While IOU functions are useful, applicant has discovered other metrics that are as, or more useful in loss functions for network training.

As noted earlier, one of the problems faced in retail checkout is associating a particular machine-readable code with a particular item. In the example just given, no machine readable code will ever be read from the over-inclusive part of the segmentation mask found in the region “A” to the lower left of the salad bottle in FIG. 35. Such area depicts only the static background. Inclusion of this area in the item mask predicted by the network is inconsequential in associating machine readable code data to depicted items.

More consequential, for checkout purposes, are segmentation errors which may be termed insufficient coverage, spillage, and absorption.

Insufficient coverage is a segmentation error in which part of the ground-truth area for a depicted item (which is commonly human-identified) is not included in the network-predicted segmentation mask for that item.

Spillage is a segmentation error in which a predicted mask for a first item extends into ground-truth area of a second item.

Absorption is a segmentation error in which a predicted mask for a first item partly overlaps a predicted mask for a second item.

These errors can be quantified in different ways, e.g., the number of pixels involved in the error region, the error region expressed as a fraction of the prediction mask area (and, where two or more masks are involved, then which mask(s)), the error region expressed as a fraction of ground-truth area (and, again, which ground-truth area(s)), etc. In an exemplary embodiment, the insufficient coverage error is expressed as the fraction of the ground-truth area for an item that is not encompassed by the predicted mask spanning the largest part of that ground-truth area. Spillage and absorption are also expressed as area fractions.

One sample procedure for evaluating network-predicted item masks is detailed below, with certain variants. It should be recognized that these are just a few of many alternative evaluation procedures that might be used.

We assume there are N ground-truth regions previously-defined for an image, as by human labeling. For the first ground-truth area, an intersection operation is performed with each of the network-predicted masks, to identify which mask provides the highest percentage coverage of that ground-truth area. This operation thereby associates one of the predicted masks with the first ground-truth area. This operation further identifies the percentage shortfall, if any, by which the mask associated with the first ground-truth area does not fully span that area (e.g., expressed as a percentage of the ground-truth area). For example, if the mask with the highest percentage coverage is found to cover 70% of the first ground-truth area, then there is a 30% insufficient coverage error. (If a different mask covers a further 25% of the first ground-truth area, we still consider this a case of 30% insufficient coverage, since that different mask isn't associated with the first ground-truth area.)

The insufficient coverage error is associated with a particular ground-truth area, but since that ground-truth area is associated with a particular predicted mask, the insufficient coverage error can likewise be said to be an attribute associated with that mask.

In a first particular procedure, if the insufficient coverage error exceeds a threshold value (e.g., 25%), then the next-detailed steps (assessing spillage and/or absorption error) are skipped, and the just-described procedure is applied in connection with the next (e.g., second) ground-truth area. That is, if a sufficiently-large insufficient coverage error is found for a ground-truth area, then spillage and absorption in connection with that area are not evaluated. In a second particular implementation, however, the next-detailed steps are performed regardless of the outcome of the just-described procedure.

Spillage may be assessed next. An evaluation is conducted to determine the amount by which the mask associated with the first ground-truth area overlies (intersects with) all of the other ground-truth areas. For example, if the mask associated with the first ground-truth area overlies 5% of the second ground-truth area and 17% of the third ground-truth area, we find this predicted mask has a 22% spillage error. Spillage error is thus an attribute of a predicted mask (which in turn is associated with a particular ground-truth area).

In the first particular procedure, if the spillage error exceeds a threshold value (e.g., 20%), then the next-detailed step (assessing absorption error) is skipped, and the process returns to the start to consider the next (e.g., second) ground truth area. That is, if a sufficiently-large spillage error is found in connection with a mask, then absorption involving that mask is not considered. In the second particular implementation, however, the next-detailed step is performed regardless of the amount of spillage error.

While assessment of spillage considers intersection between the mask associated with a particular ground-truth area and other ground-truth areas, absorption considers intersection between this mask and the other masks. As with spillage, this error can aggregate several different overlaps. If the mask overlies 12% percent of another mask, and 15% of still another mask, its absorption error is 27%. (As indicated, different implementations can express these fractions as percentages of the first mask area, or as fractions of the other mask(s) area(s), or as pixel counts, etc.)

Absorption is an attribute of a predicted mask, which in turn is associated with a particular ground-truth area. But since absorption involves two overlapping masks, it never occurs in isolation, i.e., only for one predicted mask in an image. If a network predicts one mask having absorption error, then there is at least one other mask that also has absorption error.

After the first ground-truth area has been assessed as described above (including identification of an associated mask, a check of insufficient coverage, and possible assessment of the associated mask's spillage and absorption errors), the same assessment is performed in connection with the second through Nth ground-truth areas.

While the procedure and variants just-described consider spillage before absorption, this is not critical; the ordering can be reversed. Indeed, the errors may be assessed in any order. And in some procedures, not all three errors are assessed; fewer (or more) errors can be evaluated. Intersection over Union can be evaluated, too, in some instances.

After all ground-truth areas have been assessed, and associated with corresponding masks, a check is made to determine if there is any mask that is not-associated with a ground-truth area. Each such mask constitutes an overcount error.

In a variant embodiment, each such mask constitutes an overcount error only if it is found to intersect with a ground-truth area. (Masks can be used to define regions of interest, i.e., to limit the image area that is examined to recognize items, such as by their appearance or a machine-readable code. If a mask appears in an area that spans, e.g., only background, the consequence of the error may be limited some mis-directed processing cycles. A consumer will not be over-charged without an identification of a particular item, and no particular item will be identified from such a background area.)

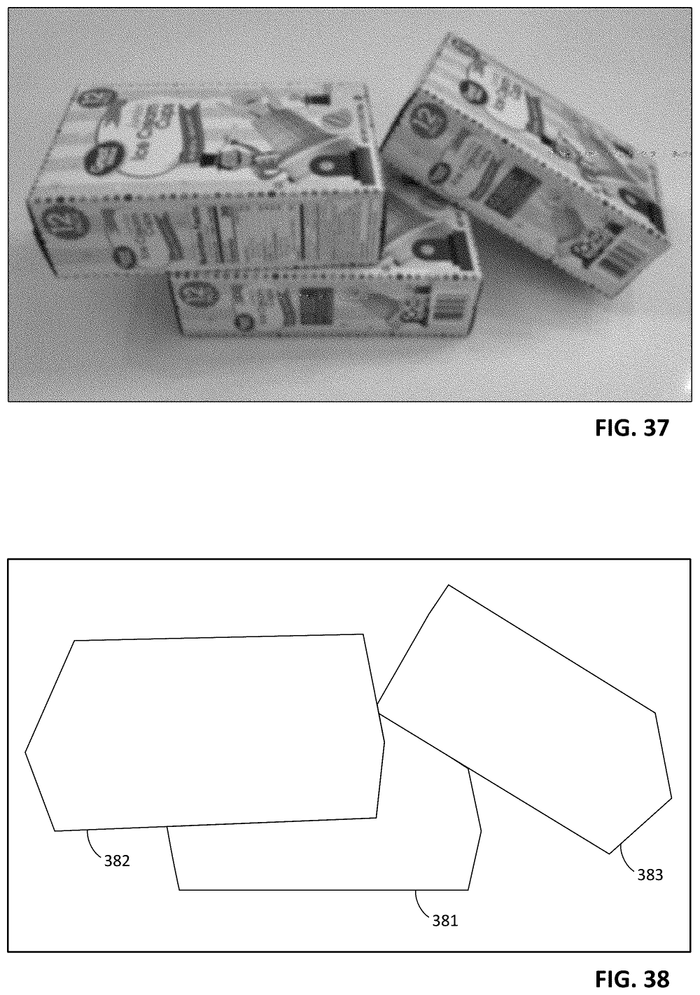

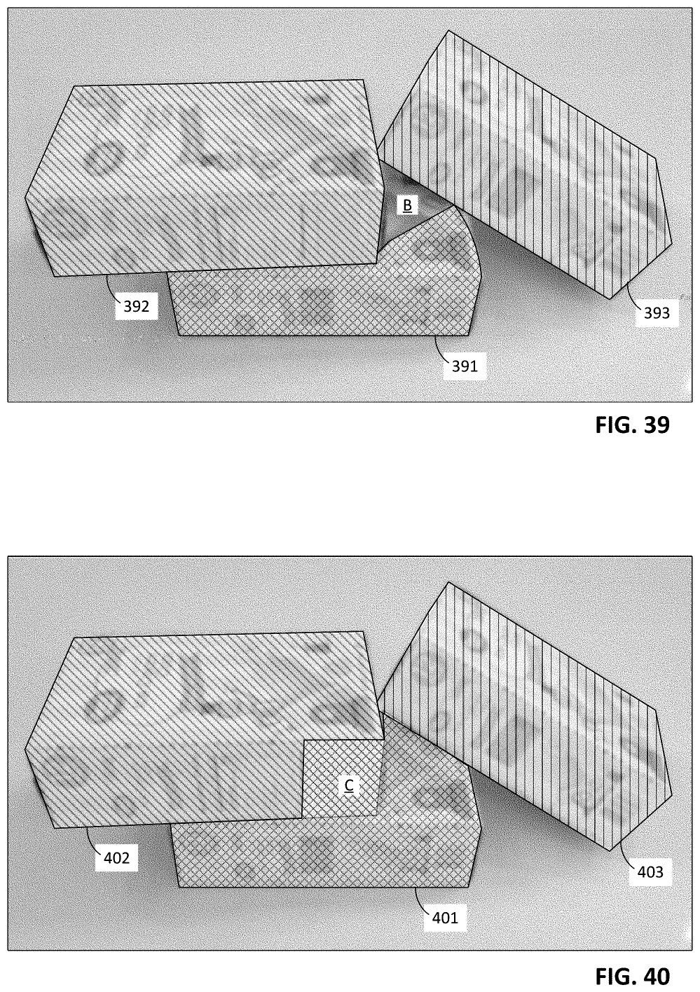

To illustrate aspects of the foregoing, consider the image of FIG. 37, depicting three boxes captured in imagery by a camera at a checkout station. A human annotates the image to define three ground-truth areas 381, 382 and 383 for the three depicted items. These annotations are shown in FIG. 38. When a network attempts a pixelwise segmentation on this image, shown in FIG. 39, it may predict three masks 391, 392 and 393. But in this instance, the predicted mask 391, which generally corresponds to the ground-truth area 381 of FIG. 38, has insufficient coverage—it omits the pixels in the area denoted “B.” Thus mask 391 suffers from an insufficient coverage error. The magnitude of this error is defined by the area of the omitted pixel area “B” as a fraction of the total area of ground-truth area 381.

Or the network may make a different mistake, as depicted in FIG. 40. In this example, an area of pixels “C” has been erroneously included in the predicted mask 402, while mask 402 has been shortchanged those pixels. When ground-truth area 381 is evaluated, this incursion of mask 401 into the ground-truth of area 382 will be identified as a spillage error. When ground-truth area 382 is evaluated, this shortfall in coverage of predicted mask 402 will be identified as an insufficient coverage error. Both types of errors, however, derive from the same erroneously classified group of pixels.

In some variant procedures, if a patch of pixels is identified that gives rise to two errors (as with area “C” in FIG. 40), only one of the errors is usually flagged (e.g., the first to be discovered). Improvement of the one error in such circumstances will usually likewise improve the other.

In another situation the network may make a different mistake, by including the “C” area of pixels in FIG. 40 in both masks 401 and 402. Depending on the evaluation procedure, this may be identified as a spillage error and/or an absorption error for mask 401; it both spills into another ground-truth area and it overlies another mask. For mask 402, this is identified as an absorption error. (Mask 402 is actually accurate insofar as coverage of ground-truth area 382 and spillage into other ground-truth areas is concerned).

The error(s) for mask 401 may be quantified as the area occupied by the overlapping pixels, as a fraction of the total area of mask 401. The error for mask 402 can be quantified as the area occupied by the overlapping pixels, as a fraction of the total area of mask 402.

As in the earlier-discussed case of spillage, the errors with both masks 401 and 402 arise from the same area “C” of pixels. In variant implementations, only one error is flagged, reasoning that network training to reduce the error of one mask will reduce the other error as well.

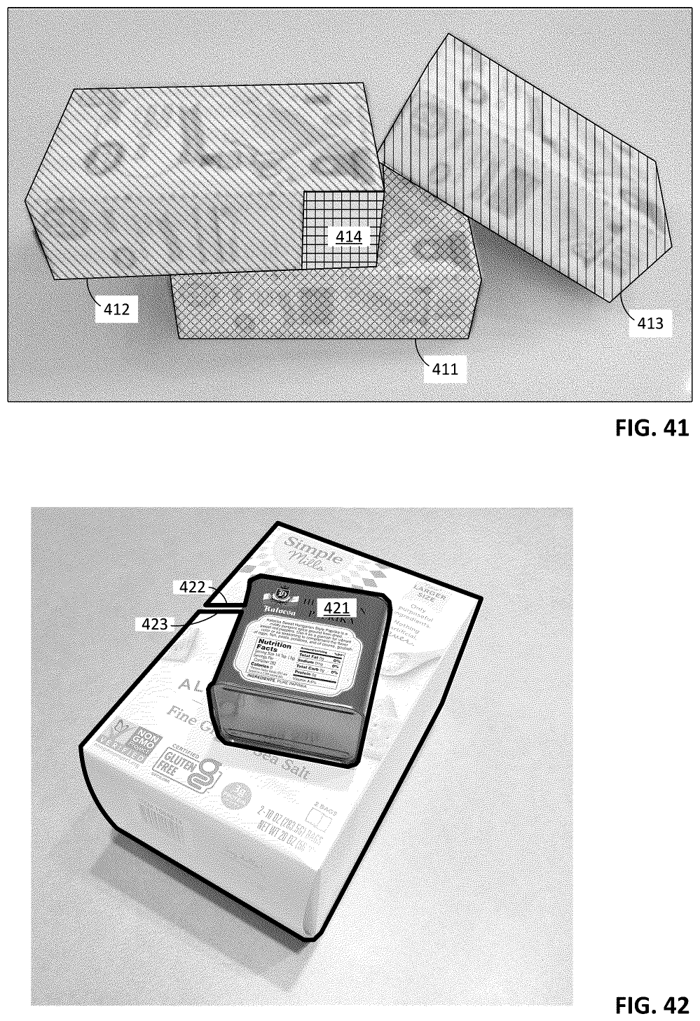

In still another circumstance the network may make yet a different mistake, by predicting a fourth mask 414, as shown in FIG. 41. Each of the ground-truth areas (381, 382, 383) is already associated with a corresponding mask (411, 412, 413), so mask 414 is surplus. This mask is flagged as an overcount error.

Where, as in the present example, an overcount mask overlies a ground-truth area, its presence will trigger either an insufficient coverage error for that ground-truth area (if the mask associated with that ground-truth does not extend into the overcount mask area), or an absorption error (if the mask associated with that ground truth overlies the overcount mask error). In either event, minimization of the coverage or absorption error will tend to resolve the overcount error.

In training a network to achieve performance that meets plural error constraints, it helps to establish the relative importance of the different errors. This acknowledges the fact that the network cannot be trained perfectly, and thereby shifts the focus of the training task to, e.g., minimizing one type of error while keeping a second type of error beneath a threshold value. Or where, as here, three or more errors are identified, then the training task can focus on minimizing one or two errors while keeping the other(s) beneath a threshold.

The thresholds used will depend on the context of the particular application, and are typically set empirically. For example, when most of the items to be identified are marked with a digital watermark signal over most of their surface area (thereby permitting identification of items from even partial depictions), then the insufficient coverage error is relatively less critical than, for instance, when items are each marked only at one location, as by a 1D barcode.

In one embodiment, applicant trains a convolutional neural network to keep spillage and absorption each constrained to a worse cast of 20% or less, while minimizing insufficient coverage error to the degree possible-typically resulting in a worst case of 25% or less.

From a procedure such as the earlier-described evaluation, each mask may be described by a collection of attributes, e.g., characterizing its association with a ground-truth area, and specifying its various errors. In one embodiment, a vector of five data is associated with each mask, identifying (i) the associated ground-truth area, (ii) the magnitude of the insufficient coverage error, (iii) the magnitude of the spillage error, (iv) the magnitude of the absorption error, and (v) whether the mask is found to be an overcount error. Some or all of this data can be included in one or more of the loss functions by which the network is trained, e.g., by gradient descent.

Often a network has different output stages (sometimes termed “heads”), e.g., respectively producing class proposals (object detection confidence), bounding box proposals (object localization), and mask proposals (object boundaries). Different loss functions are typically used to learn parameters for each. Loss functions used for the mask proposal output stage can include the foregoing attributes, e.g., in a weighted polynomial function of the sort referenced earlier, expanded to the number of attributes used. (These attributes can also be employed in training earlier stages of the network before the output stages, e.g., feature development backbone and feature pyramid stages.)

The weights used in the loss function(s) may be changed during training. For example, in initial epochs of training, the focus may be on insufficient coverage error. This attribute of mask errors is given a large weighting, whereas only small penalties are assessed for other errors (i.e., small weights for spillage and absorption errors). After such training has driven-down the mean and max insufficient coverage error in a set of test images, then the weighting for one or more of the other errors can be increased. Subsequent epochs of training can then drive down those errors, while insufficient coverage error continues to be prioritized. Not all errors can be driven to zero, so it is left for the system designer to empirically determine which combination of residuals errors is most acceptable in the particular application being served.

When the trained network is used, e.g., in connection with identifying retail food or other items for checkout, segmentation errors may still occur, albeit rarely. When two masks overlap, one is given precedence and the other is disregarded, based on the confidence score provided by the network and associated with each mask.

Desirably, training employs progressively more-challenging training data. That is, images that show high errors in coverage, spillage and/or absorption are periodically added into the training set, while images with low error rates can be retired from the training set. The training data set is thus progressively made more challenging, in terms of persistent errors in coverage, spillage and/or absorption, forcing network learning to focus on the difficult cases, rather than further-improving performance in already-satisfactory cases. Such an active training regimen is detailed in U.S. Pat. No. 10,664,722.

There are various commercial tools that human workers can employ in defining ground-truth data (e.g., segmentation boundaries) for use in training a neural network. An example is the Data Labeling tool included in the Machine Learning Studio software offered with the Microsoft Azure platform. However, images of checkout scenes present unique challenges in segmentation.

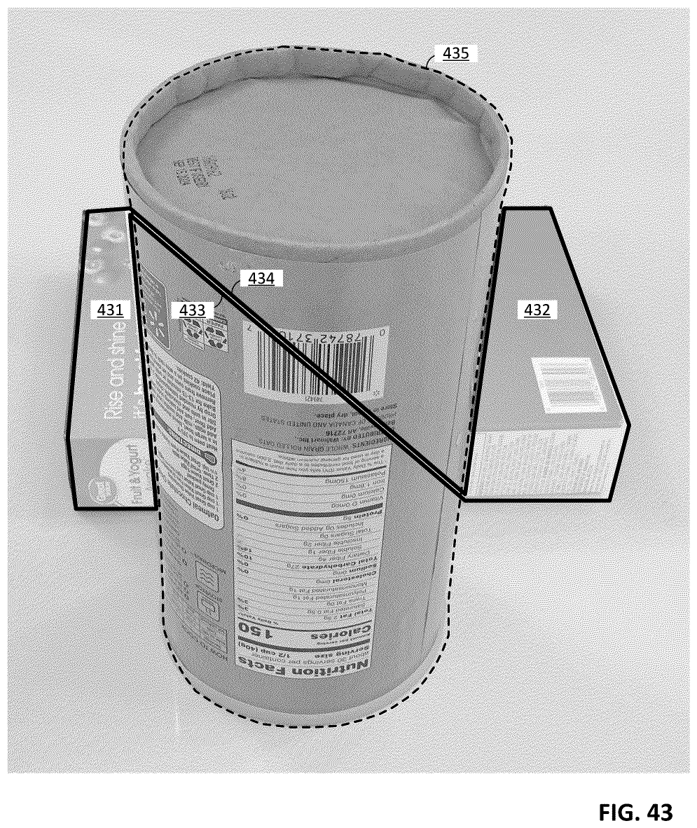

For example, sometimes a first item is positioned and depicted so that it is bounded on all sides by a second item. FIG. 42 gives an example, in which a small spice can is resting on top of a large cracker box. The area of pixels depicting the spice can is surrounded by pixels depicting the cracker box. When defining a boundary segmenting the box, applicant takes care to avoid including the spice can inside the boundary of the box. That is, the cracker box boundary is drawn so as to exclude, from its interior, the spice can. This can be done by the illustrated dark border, which briefly leaves the true boundary of the cracker box to divert to the interior area and carve-out a region of pixels 421 that is not included among the pixels depicting the cracker box. The border then diverts back out to the true boundary of the cracker box to continue along the true box boundary.

While these border lines (422, 423) diverting-in and -out of the central area are shown as spaced-apart in FIG. 42, this is for illustrative clarity only. More typically, both lines are coincident, so no area is defined between these two lines.

A second, separate boundary defines the pixel area that depicts the spice can, and is just-within the carve-out region 421. This second boundary is not shown in FIG. 42, for clarity's sake.

FIG. 43 shows a scene in which a first item (a cereal box) is occluded by a second item (an oatmeal cannister). The occlusion causes the depicted parts of the cereal box to be presented as two disjoint parts, 431 and 432. In defining the ground-truth area for the cereal box, the two disjoint parts are outlined in a connected fashion, as shown by the solid dark boundary. The connection takes the form of two parallel line segments extending between the two parts. As before, the two lines (433, 434) are shown as spaced-apart in FIG. 43, but in reality they are very close or, preferably, coincident. (While parallel straight line segments are illustrated, such lines needn't be straight or parallel.)

FIG. 43 also shows the ground-truth boundary 435 for the oatmeal cannister, by the lighter, dashed, line. All of the pixels within the boundary 435 are associated with the oatmeal cannister. This includes pixels between lines 433 and 434, but these latter lines are so close (or coincident) that the overlap in area between the pixels associated with the oatmeal cannister and the cereal box is so small as to be inconsequential.

### Variable Focus

The depth of field of a camera is a function of factors including the lens aperture and the focal length. The aperture size, in turn, relates to the exposure interval. To obtain a sharp image, a short exposure interval is preferred. But a short exposure interval commonly requires a large aperture—especially if imagery is captured with only ambient lighting (rather than, e.g., flash lighting). And a large image aperture produces a small depth of field.

To image an entire checkout surface, e.g., with an overhead camera such as camera 92 in FIG. 9, it is necessary for the camera to be placed sufficiently distant so that the camera's angular span of view encompasses the full extent of the checkout surface. This distance is commonly many tens of centimeters. However, due to environmental constraints such as lighting, aperture and exposure interval, the camera's depth of field may be only five or ten centimeters. This poses problems when plural items are on the checkout surface yet are of different sizes.

For example, a first item positioned on the checkout surface may be tall (e.g., a cercal box) and present a surface for imaging (e.g., the box top) that is near an overhead camera, e.g., less than 15 cm from the camera lens. A second item on the checkout surface may be short (e.g., a candy bar) and present a top surface for imaging that is distant from the overhead camera, e.g., more than 30 cm from the camera lens. The environmental constraints prevent the two items from being in-focus in a single image.

To address this difficulty, the focus of the camera can be adjusted. The focus can be set to bring the top of the first item into focus for capture of one or more images, and then the focus can be adjusted to bring the second item into focus for capture of one or more further images. In the former image(s), the view of the first item is in focus while the view of the second item is out-of-focus. In the latter image(s), the view of the second item is in focus while the view of the first item is out-of-focus.

Conventional auto-focus technologies will not serve in this application. Such technologies commonly adjust the camera focus while monitoring sharpness or contrast of the captured image in a region of interest-commonly an area in the center of the image frame. Accordingly, such a camera will typically auto-focus on whichever of the first or second items is closest to the center of the image frame, and the other item will be out-of-focus. (Nor does it generally suffice to set the focus at a mid-point between the surfaces being imaged in the field of view. In such circumstance, both items may be out of focus.)

Focusing is commonly effected by adjusting a distance between the camera's photosensor and the camera's lens. Either the photosensor or the lens may be physically moved while the other element stays fixed. Various mechanisms can serve to effect the adjustment, e.g., a screw drive, a stepper motor, a piezo-electric positioner, etc. Alternatively, rather than physically adjusting a distance between the two elements, the focus can be changed by varying the focal length of the lens. This is the principle behind so-called liquid lenses, in which the curved lens surface is not made of glass but of liquid. Electrowetting, shape-changing polymers, and acousto-optical tuning methods can be used to control the lens's radius of curvature and/or refractive index. Camera focus can thereby be electronically controlled and changed within a fraction of a second.

In one embodiment, a camera's focal distance is adjusted back and forth across its range—capturing in-focus imagery at different zones within the viewing volume. Sharp excerpts of imagery (e.g., as judged by edge contrast metrics) can be retained from the captured imagery, while other, out-of-focus excerpts of imagery can be discarded. The sharp excerpts of different image frames can be combined together to yield a composite image in which item surfaces at widely-different distances from the camera (e.g., 10, 15 or 20 or more cm) are all in-focus. The composite imagery can then be processed to identify the depicted items, such as by decoding a 2D machine-readable code, or by recognizing the items with fingerprinting (e.g., SIFT) or neural network methods.

Such naïve method is effective, but it is relatively slow and computationally inefficient.

Preferable is to receive 3D representation data for the checkout surface scene, and then direct the camera focus, sequentially, to the depths of fields adequate to obtain in-focus imagery for each item on the checkout surface. For example, if depth of field is 10 cm, one may sample depths in 7 cm slices, as not every mm of depth needs to get captured. When 3D data is provided, cameras do not need to capture the whole field of view as smaller regions need to be captured. Applying regions to capture speeds up camera frame rate, as there is less bandwidth needed to transfer data.

Obtaining the 3D representation can be achieved by a depth-sensing system. Some depth-sensing systems operate by projecting an infrared pattern of dots in a viewing space, and then detecting the pattern by an offset infrared-sensing camera. The detected spatial arrangement of the dots reveals the 3D shape of the surfaces on which the pattern is projected. Other depth-sensing systems operate using stereoscopy—capturing a pair of images of a scene from offset viewpoints and computing—from data including pixel positions of features in the different images—the distances to those features. Still other depth-sensing arrangements rely on time of flight technologies—illuminating a scene with a short laser pulse, and measuring the intervals that elapse before the light is reflected back to an associated camera sensor from different locations in the illuminated scene.

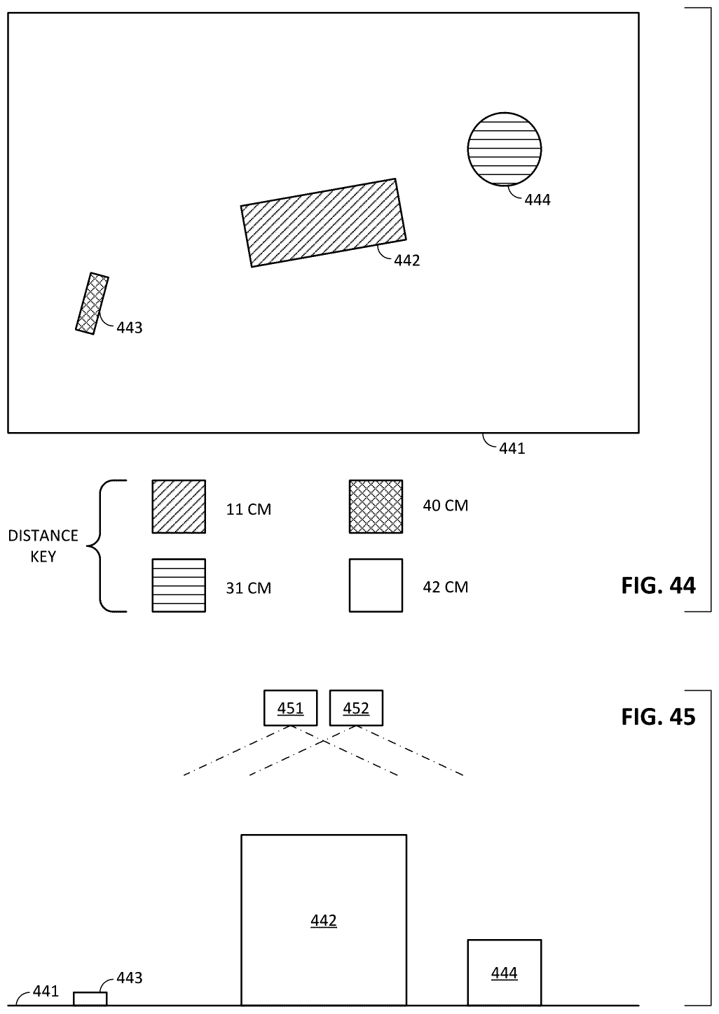

A 3D representation of a checkout surface scene, captured from an overhead view, may indicate an arrangement of items and associated distances as shown in FIG. 44. The checkout surface 441 is shown in white. On the checkout surface are shown a cereal box 442, a candy bar 443 and a soup can 444, all as sensed looking down from a depth-sensing system 451 (FIG. 45) that is located a short distance from a downward-looking camera 452, typically mounted at the same elevation. The Key indicates the sensed distances from the depth-sensing device to the indicated surfaces. The cereal box is closest, at a distance of 11 cm. The soup can is shorter and is 31 cm from the depth-sensing device. The candy bar is still shorter and is 40 cm distant. Most-remote is the checkout surface itself, at a distance of 42 cm.

A side view (not to scale) of the FIG. 44 scene is shown in FIG. 45.

(The reader will note that FIG. 44, and associated description, make over-simplifications in service of illustrative clarity and expositive brevity. For example, not all points on the checkout surface are 42 cm from the depth sensor. Instead, points along the peripheral edge of the checkout surface are more distant than points near the center of the checkout surface. Likewise for the distance measurements to other surfaces, albeit by smaller amounts.)

The depth-sensing system 451 typically has a horizontal (in the FIG. 44 view) spatial resolution that is less than that of the adjacent camera 452. For example, the depth-sensing system may have a resolution of 640×480, or 1280×720, while the imaging camera may have a resolution of 1920×1080, or 4000×3000, etc. (Focal lengths of the stereo cameras (for IR dots) and high-res RGB camera may also be different. This is useful to be able to see “hands” in the field of view of 3D camera before seeing them in the high resolution imagery.)

An illustrative method includes receiving 3D representation data for a scene that includes first and second items in a checkout area (e.g., items 442 and 443 in area 441). Variable focus of a first camera (e.g., camera 452) is adjusted to bring a first view of the first item into focus. One or more first images are captured. Then, without re-orienting the camera, the focus of the first camera is changed to bring a first view of the second item into focus. One or more second images are captured. By this arrangement, the captured imagery includes (i) one or more images with the first view of the first item in focus and the first view of the second item out-of-focus; and (ii) one or more images with the first view of the second item in focus and the first view of the first item out-of-focus.

In some embodiments, the illustrative method further includes providing the one or more first images and the one or more second images, or data derived from such images, to a retail point-of-sale system, e.g., for decoding of machine-readable indicia.

In some embodiments, after the second images are captured, focus of the first camera is restored to bring the first view of the first item back into focus. One or more addition first images are then captured after such focus restoration. This may occur, e.g., upon detection that the second item has been removed from the checkout area.

Some embodiments further include receiving updated 3D representation data for the scene, including a third item that has been added to the checkout area. In such case, and again without reorienting the first camera, the camera's variable focus is further changed to bring a first view of the third item into focus. One or more third images are then captured. By such arrangement, the captured imagery includes (i) one or more images with the first view of the first item in focus and the first view of the second item and the first view of the third item out-of-focus; (ii) one or more images with the first view of the second item in focus and the first view of the first item and the first view of the third item out-of-focus; and (iii) one or more images with the first view of the third item in focus and the first view of the first item and the first view of the second item out-of-focus.

The illustrative method can also employ a second camera. In one embodiment, the method then includes adjusting a variable focus of the second camera to bring a second view of the first item into focus, and capturing one or more images of the first item. Without re-orienting the second camera, the variable focus of the second camera is changed to bring a second view of the second item into focus, and one or more images of the second item are captured. In such arrangement, the captured imagery then includes (i) one or more images with the first view of the first item in focus and the first view of the second item out-of-focus; (ii) one or more images with the first view of the second item in focus and the first view of the first item out-of-focus; (iii) one or more images with the second view of the first item in focus and the second view of the second item out-of-focus; and (iv) one or more images with the second view of the second item in focus and the second view of the first item out-of-focus. Such method can also be extended to receiving updated 3D representation data for the scene, including a third item that has been added to the checkout area, in which case the variable focus of both the first and second cameras can be adjusted to capture first and second in-focus images viewing the third item as well (in which case the respective camera views of the first and second items may be out of focus).

Similarly, the illustrative method can employ a third camera. In one embodiment, the method can then include adjusting a variable focus of the third camera to bring a third view of the first item into focus, and capturing one or more images. The method can further include, without re-orienting the third camera, changing its variable focus of the third camera to bring a third view of the second item into focus, and capturing one or more images of the second item. By such arrangement, the captured imagery includes (i) one or more images with the first view of the first item in focus and the first view of the second item out-of-focus; (ii) one or more images with the first view of the second item in focus and the first view of the first item out-of-focus; (iii) one or more images with the second view of the first item in focus and the second view of the second item out-of-focus; (iv) one or more images with the second view of the second item in focus and the second view of the first item out-of-focus; (v) one or more images with the third view of the first item in focus and the third view of the second item out-of-focus; and (vi) one or more images with the third view of the second item in focus and the third view of the first item out-of-focus.

In some embodiments, the 3D representation data is not generated by a 3D sensor, per se (e.g., by one of the dedicated 3D sensing arrangements detailed earlier). Rather, 3D representation data is derived from the imagery produced by use of cameras that do image collection, such as pairs of the first, second and third just-referenced cameras, or all three imaging cameras (or more). The two camera case is an application of stereoscopy. However, two cameras are usually inadequate to obtain a complete 3D data set, since some item surfaces will not be visible to both cameras. The three camera case may be handled as three pairs of stereo cameras (i.e., first and second, first and third, and second and third), whose 3D representations are used jointly, e.g., by averaging or otherwise.

It will be recognized that each pixel in a 2D image frame depicts a scene point found somewhere along a straight line from the camera into a viewing space. For a pixel in the center of the image frame, this straight line is typically straight out from the camera, along the axis of the lens. Other pixels correspond to straight lines directed in a particular azimuth and elevation relative to the lens.

(It can also be desirable to sweep through lens focal distance and combine the captured frames based on either local sharpness or 3D-combined together in a single frame (known as focus bracketing in photography). This is useful for certain application, such as running AI recognition model on the whole scene.)

As is familiar, two straight lines in 3D space intersect, at most, at a single point in the 3D space. Thus, if a scene point is found at a particular pixel in one camera's image frame, and is also found at a particular pixel in a second camera's image frame, that pixel pairing uniquely characterizes the point's position in 3D space. The DepthAI software package, earlier-referenced, provides tools for generating 3D representations from multiple camera views. Other such software is available from other sources.

A related approach to camera-based 3D representation generation is by sensing object edges in imagery captured by different cameras, which view the object from different viewpoints. Collectively such silhouettes from multiple views define the 3D object shape. Additional information on such methods of generating 3D representations from camera data is found in Martin et al, Volumetric descriptions of objects from multiple views, IEEE Transactions on Pattern Analysis and Machine Intelligence, 5 (2): 150-174, March 1983. Additional information is found in U.S. Pat. Nos. 7,327,362, 7,209,136, 6,850,586 and 6,455,835. The disclosures of these five documents are incorporated herein by reference.

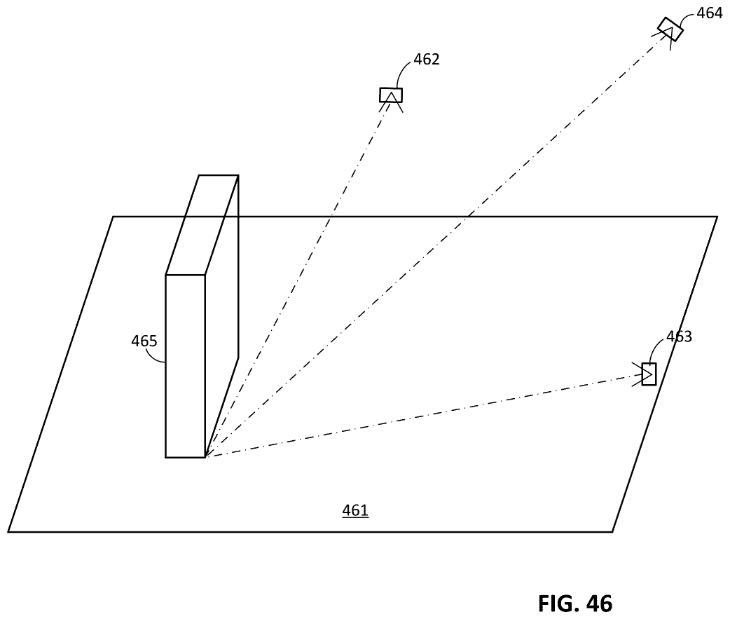

FIG. 46 is a schematic illustration of a checkout surface 461 viewed by three cameras. Two cameras 462, 463 are mounted above the checkout surface and look down towards objects on the surface. The third camera 464 is mounted next to the surface and looks out across it. A scene point, such as a corner of a box 465, is visible to each camera. This scene point typically appears at different pixel locations in each camera frame, and with knowledge of these pixel locations (and typically other parameters, e.g., including camera geometry and lens parameters), the location of the scene point in a 3D representation can be established, using the DepthAI software or otherwise.

Digital watermarks may be encoded at spatial resolutions of 150 watermark elements (“waxels”) per inch. Desirably, the resolution of each camera is sufficient so that an item, at a most remote possible location on the checkout surface relative to the camera, is imaged with a resolution of 150 pixels per inch. In such arrangement, depiction of each watermark element spans at least one pixel. For example, a camera looking down on the checkout surface can be chosen (e.g., photosensor and lens optics) so that each location on the checkout surface is imaged with a resolution of 150 pixels per inch. However, due to error correction features of the watermark encoding, the payload can generally be decoded at lower resolutions, but resolution should desirably be greater than 100 pixels (waxels) per inch.

Since watermark patterns are often encoded in a chroma channel, rather than in the luma (greyscale) channel, it is necessary for the camera to have sufficient resolution in the appropriate color channel. For example, to obtain a greater than 100 pixel per inch red imaging resolution with a color imager employing a Bayer color filter array, the camera should have a physical photosensor density greater than 200 pixels per inch. In such a camera, each 2×2 grouping of pixels includes one red-filtered pixel. Thus, 200 pixel per inch photosensor resolution is needed to obtain 100 pixel per inch red resolution. (For consumer imaging, interpolation is used to fill-in red data at photosensor locations having blue and green filters, but such interpolated data provides no additional image information, so is not useful for watermark decoding.)

The motion-aware averaging technology detailed earlier can be used with variable focus cameras. In such case, image data for a region is used for averaging only if the image data is in-focus. If camera focus is set, or changed, so as to capture a depth of field in which the surface of an item depicted in a region of camera imagery is out-of-focus, any pixel accumulation for such region of imagery is stopped.

Thus, the above-described illustrative method can include capturing a series of first images after adjusting the variable focus of the first camera to bring the first view of the first item into focus. Pixels in a first region associated with the first item can then be averaged, using image data from the series of first images. Such method can further include capturing a series of second images after adjusting the variable focus of the first camera to bring the first view of the second item into focus. Pixels in a second region associated with the second item can then be averaged, using image data from the series of second images. A composite image can then be produced using both the averaged pixels in the first region and the averaged pixels in the second region.

Another such method again employs a first stationary camera directed to an image scene comprising a checkout surface on which items are placed for retail checkout. A series of image frames depicting the scene are received from the first stationary camera. Each frame includes a first region comprising a first set of pixels and a second, different region comprising a second set of pixels. For a first frame in the series, data corresponding to values of the first set of pixels are stored in a first memory. For each of second through Nth frames following the first frame in the series, data corresponding to pixels in the first region are combined with data previously-stored in the first memory. The focus of the camera is then changed. Thereafter, for a frame subsequent to the Nth frame in the series, the method includes storing data corresponding to values of the second set of pixels in a second memory (i.e., and not combining data corresponding to pixels in the first region of the subsequent frame with data previously stored in the first memory). For each of plural frames following this subsequent frame in the series, data corresponding to pixels in the second region are combined with data previously-stored in the second memory. A composite image is then produced including (i) an averaged representation of pixels in the first region, employing the combined data in the first memory, and (ii) an averaged representation of pixels in the second region, employing the combined data in the second memory.

In this and in the other embodiments, the frames of the noted series can be, but need not be, captured consecutively at periodic intervals.

Naturally, image data of an object captured with one or more variable-focus cameras, optionally processed to effect motion-aware averaging, and composited with images of other objects, using the technologies detailed above, can be employed in the neural network-based arrangements detailed herein.

### Concluding Remarks

Having described and illustrated the technology with reference to exemplary implementations, it will be recognized that the technology is not so limited.

For example, while certain of the detailed methods accumulate a running sum of pixel values for a particular region of imagery in a corresponding memory, techniques other than simple summing can be used. For example, in another embodiment, a moving average or a weighted moving average technique is used, such as exponential averaging. In another embodiment, a moving mean technique is used. Some of these techniques require buffering histories of individual pixel values. Thus, the references to accumulating, summing and averaging data should be understood as shorthand that encompasses such alternate arrangements.

While certain embodiments contemplate accumulating pixel data from across the frame, in other embodiments a more selective approach is used. That is, pixels from a region of imagery are accumulated only if the region has hallmarks of a 2D code. For a conventional barcode, such a hallmark may be a histogram that indicates both light and dark pixels, or an edge-filtered image patch showing parallel lines. For a watermark, such a hallmark can be output from a trained classifier predicting that the region may contain a watermark signal. (See, e.g., U.S. Pat. Nos. 9,521,291 and 10,217,182.) Or, inversely, a hallmark may indicate the absence of any code, such as sensing depiction of the checkout surface in a region of imagery, which region may then be ignored. As indicated, some embodiments perform a background subtraction operation on received image frames to identify regions that are other than static background, and only such regions are then considered for accumulation.

In some embodiments the pixel data is filtered before accumulation. One suitable filter is an oct-axis or oct-vector filter, e.g., as detailed in U.S. Pat. Nos. 10,515,429 and 11,410,263. Such filtering reduces sensitivity to luminance variation, as when a passing hand casts a shadow over part of the scene.

It should be understood that the pixel data may undergo other processing between its capture and its use in the detailed methods. In addition to filtering, such processing can include gamma correction, white balance adjustment, de-mosaicing, etc. Accordingly, references to captured imagery and the like should be interpreted so as to allow for such intermediate processing.

In some embodiments, the checkout stage can be strobe-illuminated, by visible or infrared light, in synchrony with image captures, to yield more brightly-lit scene data.

In some embodiments, the naïve variable-focus approach detailed earlier can be used. Each camera can rotely step its focus through several states to encompass successive depths of fields. The captured imagery can then be used in the motion-aware averaging and neural network segmentation methods detailed herein.

While the preferred variable-focus camera arrangements employ cameras that are stationary in their orientation, this is not necessary. A single camera can be steered to capture one field of view, and capture multiple frames with different focus settings, and then be steered to capture a second, different field of view, and capture multiple further frames with different focus settings.

Features and attributes associated with different of the embodiments can be combined. For example, while the embodiment illustrated by FIGS. 10A-10G employs an array of image blocks of fixed sizes (e.g., 320 pixels on a side), such embodiment can instead be based on variable-sized blocks, such as regions 31 and 32 in FIG. 3B. Similarly, while the embodiment illustrated by FIGS. 10A-10G accumulates buffer data until a change is detected in the corresponding image block, accumulation can alternatively cease when data from a threshold number of frames “K” has been accumulated, as noted in connection with an earlier embodiment.

Although described embodiments produce composite frames when requested, or at periodic intervals, other arrangements can be used. For example, to avoid loss of accumulated data, the system can be configured to produce a composite frame whenever motion is detected in one of the blocks, which triggers a reset of the corresponding block buffer. By this method, data previously-accumulated in that buffer is memorialized in an output frame before the buffer is reset. In some such embodiments, a composite frame is output only if a to-be-reset buffer has accumulated data from at least a threshold number of frames, such as ten.

Although not belabored, it will be understood that the bounding boxes, blocks and pixel regions referenced above are typically stationary across successive frames. For example, their location and extent can be defined within a coordinate system defined by rows and columns of pixel data in the captured image frames.

Some embodiments make use of 3D scene representations. The form of representation used is not critical. It may comprise, for example, a point cloud. Or a polygon or voxel (“volume element”) model. Or, as in FIG. 44, a depth image may be used. Etc.

3D scene representations also aid with 2D symbol decoding. A barcode, digital watermark, or other indicia may be found on a surface that is oriented with its surface normal directed away from a viewing camera. In such instances, the indicia will be depicted with geometric distortion. Moreover, the scale of the indicia depicted in captured imagery will vary with the distance between the camera and the item surface. With 3D knowledge concerning arrangement of item surfaces, these and other affine distortions can be predicted, and the symbol decoder can be configured in anticipation of the distorted indicia depiction. Or, the captured imagery can be processed (e.g., interpolated) so as to counteract the affine distortion, and present the indicia in a desired affine state for decoding.

3D scene representation also enables items on the checkout surface to be classified by geometric shape, such as box, can, or irregular. (The latter may encompass, e.g., bags of chips, egg cartons, fresh vegetables, etc.) A convolutional neural network can be trained to make such classification based on the 3D representation data. This knowledge, in turn, can speed item identification. Whether in decoding a 2D symbology, or recognizing an item by fingerprint features (e.g., SIFT points) or by neural network recognition, being able to limit the item's identity by shape class limits the universe of possible item identities and thereby simplifies the identification task.

Item shapes may be further classified by size. For example, the 3D representation data enables an analysis system to discern that one box shape is large (e.g., with a longest dimension of 25 cm or more) and another box shape is small (e.g., with a longest dimension of 15 cm or less). The former box shape is unlikely to be a tin of sardines. The latter box shape is unlikely to be a box of cereal. Again, by limiting the universe of candidate item identifications, item identification is simplified and made more accurate.

Shape classification can be aided by a least-squares assessment of the items being sensed. Even with noisy, low-resolution 3D representation data (e.g., as may be produced by a shape-from-silhouette technique), a least-squares evaluation technique can conclude that a particular item on the checkout surface more likely has the shape of a box than it does a can or irregular shape, etc. Such technique can compare the 3D representation of the item shape (sometimes termed a “hull”) with different prototypical object shapes (e.g., a cylinder of radius 2.5 cm and height of 8 cm, a cylinder of radius 2.5 cm and a height of 10 cm, a box of dimensions 3×10×15 cm, a box of dimensions 5×18×30 cm, etc., etc., etc.), to determine which object shape has the smallest least-square error when compared to the 3D hull. Once the general shape classification of the item is determined, it can be refined by varying the dimensions of the prototypical object shape to minimize a least square error metric between the re-sized object and the 3D hull.

In performing item shape classification, it is helpful that the checkout surface is a planar geometric constraint. Most items will have a flat item surface that is coincident with the plane of the checkout surface. Such limitation in possible presentations and depictions of items (e.g., a box is not likely to be presented balancing on one corner) simplifies the classification task.

3D scene representation also aids item segmentation, and provides information by which pixels in captured imagery can be associated with different items on the checkout surface. In particular, the 3D representation can be mapped to the view, and pixel map, of each camera, enabling each image pixel to be associated with a different 3D location. If the different 3D locations are recognized to be parts of different items, then the pixel data can be segmented accordingly—with certain pixels associated with one 3D item, and other pixels associated with a different 3D item. (Recognizing different 3D locations as parts of different items can be accomplished by detecting spatial gaps between the items, by detecting differences in item shapes (e.g., two touching box shapes of different sizes), etc.)

As noted, the depicted items often include machine-readable codes, such as digital watermark or barcodes. The watermarks can be sparse (binary) or continuous tone watermarks. Continuous tone watermarks can be of different forms, e.g., in which the pattern is formed in the luminance domain or in the chrominance domain.

The term “watermark” commonly denotes an indicia that escapes human attention, i.e., is steganographic. While steganographic watermarks can be advantageous, they are not essential. Watermarks forming overt, human-conspicuous patterns, can be employed in embodiments of the present technology.

For purposes of this patent document, a watermark (sometimes termed a digital watermark) is a 2D code produced through a process that represents a message of N symbols using K output symbols, where the ratio N/K is less than 0.2. (In convolutional coding terms, this is the base rate, where smaller rates indicate greater redundancy and thus greater robustness in conveying information through noisy “channels”). In preferred embodiments, the ratio N/K is 0.1 or less. Due to the small base rate, a payload can be decoded from a watermark even if half or more (commonly three-quarters or more) or the code is missing.

In the illustrative watermarking arrangement, 47 payload bits are concatenated with 24 CRC bits, and these 71 bits (“N”) are convolutionally encoded at a base rate of 1/13 to yield 924 bits (“K”). A further 100 bits of version data are appended to indicate version information, yielding 1024 bits. These bits are then scrambled and spread to yield the 16,384 values in a 128×128 watermark signal pattern.

Some other 2D codes make use of error correction, but not to such a degree. A QR code, for example, encoded with the highest possible error correction level, can recover from only 30% loss of the code.

Many watermark embodiments are also characterized by a synchronization (reference) signal component that is expressed where message data is also expressed. For example, every mark in a watermark is typically a function of the synchronization signal. Again, in contrast, synchronization in QR codes is achieved by alignment patterns placed at three corners and at certain intermediate cells. Message data is expressed at none of these locations.

Watermarked objects from which imagery is captured can be, e.g., product packaging or printed media. The watermark pattern can be rendered by printing, e.g., with ink or clear varnish. Alternatively, the watermark pattern can take the form of a surface texture. Texturing can be accomplished by laser etching, thermoplastic molding (e.g., blow molding, injection molding), etc.

Addition details on watermark encoding and decoding is found in U.S. Pat. Nos. 6,590,996, 9,959,587, 10,242,434 and in U.S. patent publications 20190332840 and 20210299706. A commercial software development kit for implementing digital watermark reading is available from Digimarc Corporation as the Digimarc Embedded Systems SDK.

Barcode decoders are familiar to the artisan. One favored by applicants is detailed in U.S. Pat. No. 10,198,648. Localization of likely barcode, or other 2D symbology (e.g., watermark), can employ methods detailed in U.S. Pat. No. 9,892,301.

One particular arrangement for use of color histograms to identify items is shown in U.S. Pat. No. 9,135,520.

Exemplary image fingerprinting techniques are detailed in U.S. Pat. No. 7,020,304. The popular scale invariant feature transform (SIFT) fingerprinting technique is detailed in Lowe, “Distinctive Image Features from Scale-Invariant Keypoints,” International Journal of Computer Vision, 60, 2 (2004), pp. 91-110; Lowe, “Object Recognition from Local Scale-Invariant Features,” International Conference on Computer Vision, Corfu, Greece (September 1999), pp. 1150-1157, and in U.S. Pat. No. 6,711,293.

Implementations employing optical character recognition can employ open-source software tools, such as those from Tesseract (e.g., Tesseract Open Source OCR Engine) and ABBYY (e.g., FineReader Engine).

Certain details of applicant's previous work in retail checkout technology are detailed in U.S. patent publication 20140052555 and pending U.S. application Ser. No. 17/966,670, filed Oct. 14, 2022.

Neural network implementations are widely available from github repositories and from cloud vendors such as Google, Microsoft (Azure) and Amazon (AWS). Open source implementations, e.g., in PyTorch or TensorFlow, are commonly posted. For image recognition and classification tasks, networks such as AlexNet, ResNet and GoogleNet are suitable. (GoogleNet is detailed in US patent publication 20160063359.)

There are several networks that are suitable for pixelwise object segmentation. These commonly are implemented as two-stage or one-stage networks. The leading two-stage network is Mask R-CNN. One-stage networks include SSD (Single Shot Detector), YOLO (You Only Look Once), and RetinaNet. The latter networks are often preferred, because their one-stage operation yields faster performance, but in some instances the former network yields more accuracy. Papers detailing the foregoing (often with pointers to associated code repositories) include:
Ren et al, Faster R-CNN: towards real-time object detection with region proposal networks, Proc. 28th Int. Conf. Advances in Neural Information Processing Systems, 2015.
He et al, Mask R-CNN, Proc. IEEE Int. Conf. Computer Vision, pp. 2961-2969, 2017.
Liu, et al, SSD: single shot multibox detector, Proc. Eur. Conf. on Computer Vision, pp. 21-37, 2016.
Zhang, et al, Single-shot refinement neural network for object detection, Proc. IEEE Conf. on Computer Visual Pattern Recognition, pp. 4203-4212, 2018.
Redmon et al, You only look once: unified, real-time object detection, Proc. IEEE Conf. on Computer Visual Pattern Recognition, pp. 779-788, 2016.
Bochkovskiy, et al, YOLOv4: optimal speed and accuracy of object detection, arXiv preprint arXiv: 2004.10934, 2020.
Bolya, et al, Yolact: Real-time instance segmentation, Proc. IEEE/CVF International Conference on Computer Vision, pp. 9157-9166, 2019.
Mohamed, et al, Insta-yolo: Real-time instance segmentation. arXiv preprint arXiv: 2102.06777, 2021.
Wang, et al, YOLOv7: Trainable bag-of-freebies sets new state-of-the-art for real-time object detectors, arXiv preprint arXiv: 2207.02696, 2022.
Lin, et al, Focal loss for dense object detection, Proc. of the IEEE international conference on computer vision, pp. 2980-2988, 2017.

There are various capable toolsets that have been designed for developing and training neural networks, and which are suitable for use with the present technology. Examples include TensorFlow (now from Google), OpenCV, Keras and PyTorch (now from the Linux Foundation). Models for many of the above networks are freely available in one or more of the indicated platforms.

Training can be performed by local hardware, such as a computer equipped with multiple Nvidia TitanX GPU cards, or training can be conducted using Azure, AWS and other cloud platforms.

Once training and testing data is available for use (e.g., after human-labeling), different of the above-identified networks can be implemented on one of the indicated platforms, and the same training/testing data can be used for each, to determine which of the networks yields results that are best-suited (in terms of accuracy and speed) for the contemplated application.

While reference has been made to human-labeling, this is not strictly necessary. For example, after a human has annotated several images with object-bounding polygons, the Azure Machine Learning Studio can take over and propose bounding polygons for objects in further images. These become more and more accurate with use, so that much of the labeling task can be handled by the Azure tool.

Moreover, once one image is labeled, other images can be created from the one by, e.g., cropping, rotating, color-shifting, noise-adding, etc. Such synthetic data methods are detailed, e.g., in U.S. Pat. No. 10,664,722 and in Nikolenko, Synthetic Data for Deep Learning, arXiv: 1909.11512, 2019.

As noted, once masks are predicted for imagery, the imagery can be analyzed to detect machine-readable codes within the mask regions. Some networks produce multiple mask proposals, which are winnowed down by a non-maximum suppression (NMS) algorithm. The winnowing history is desirably maintained briefly so that if a code is found at a location outside any final mask region, the history can be examined to determine whether such location was among those proposed and eliminated by the NMS algorithm. In such case, the code can be associated with the mask that finally emerged from the corresponding winnowing process.

While the emphasis of this disclosure has been on retail checkout applications, it will be recognized that the technology is otherwise applicable. For example, the detailed techniques can be used in connection with identification of waste items on a conveyor, e.g., for sorting by plastic type. Such arrangements are described, e.g., in US patent publications 20220055071, 20210299706 and 20220331841.

The processes and system components disclosed in this specification can be implemented as instructions for computing devices, including general purpose processor instructions for a variety of programmable processors, such as microprocessors and systems on a chip (e.g., the Intel Atom, the ARM A8 and Cortex series, the Qualcomm Snapdragon, and the nVidia Tegra 4). Implementation can also employ a variety of specialized processors, such as graphics processing units (GPUs, such as are included in the nVidia Tegra series, and the Adreno 530-part of the Qualcomm Snapdragon processor), and digital signal processors (e.g., the Texas Instruments TMS320 and OMAP series devices, and the ultra-low power Qualcomm Hexagon devices, such as the QDSP6V5A), etc. These instructions can be implemented as software, firmware, etc. These instructions can also be implemented in various forms of processor circuitry, including programmable logic devices, field programmable gate arrays (e.g., the Xilinx Virtex series devices), field programmable object arrays, and application specific circuits-including digital, analog and mixed analog/digital circuitry. Execution of the instructions can be distributed among processors and/or made parallel across processors within a device or across a network of devices. Processing of data can also be distributed among different processor and memory devices. References to “processors,” “modules” or “components” should be understood to refer to functionality, rather than requiring a particular form of implementation.

Implementation can additionally, or alternatively, employ special purpose electronic circuitry that has been custom-designed and manufactured to perform some or all of the component acts, as an application specific integrated circuit (ASIC). Additional details concerning special purpose electronic circuitry are provided in our U.S. Pat. No. 9,819,950. Software instructions for implementing the detailed functionality can be authored by artisans without undue experimentation from the descriptions provided herein, e.g., written in C, C++, Visual Basic, Java, Python, Tcl, Perl, Scheme, Ruby, etc., in conjunction with associated data.

Software and hardware configuration data/instructions are commonly stored as instructions in one or more data structures conveyed by tangible media, such as magnetic or optical discs, memory cards, ROM, etc., which may be accessed across a network. Some embodiments may be implemented as embedded systems-special purpose computer systems in which operating system software and application software are indistinguishable to the user (e.g., as is commonly the case in basic cell phones). The functionality detailed in this specification can be implemented in operating system software, application software and/or as embedded system software.

Although disclosed as a complete system, sub-combinations of the detailed arrangements are also separately contemplated (e.g., omitting various of the features of a complete system).

While aspects of the technology have been described by reference to illustrative methods, it will be recognized that apparatuses configured to perform the acts of such methods are also contemplated as part of applicant's inventive work. Likewise, other aspects have been described by reference to illustrative apparatus, and the methodology performed by such apparatus is likewise within the scope of the present technology. Still further, tangible computer readable media containing instructions for configuring a processor or other programmable system to perform such methods is also expressly contemplated.

Moreover, it will be recognized that applicant's technology extends to the server (e.g., web site) from which instructions (e.g., WebAssembly or JavaScript instructions) are downloaded to a user device, for execution by the user device.

To provide a comprehensive disclosure, while complying with the Patent Act's requirement of conciseness, applicant incorporates-by-reference each of the documents referenced herein. (Such materials are incorporated in their entireties, even if cited above in connection with specific of their teachings.) These references disclose technologies and teachings that applicant intends be incorporated into the arrangements detailed herein, and into which the technologies and teachings presently-detailed be incorporated.

In view of the wide variety of embodiments to which the principles and features discussed above can be applied, it should be apparent that the detailed embodiments are illustrative only, and should not be taken as limiting the scope of the invention.

1-40. (canceled)

41. A method comprising the acts:
receiving a frame of image data depicting first and second items as seen from a camera viewpoint;
identifying a first area of the frame as corresponding to the first item, and identifying a second area of the frame as corresponding to the second item, the first and second areas of the frame having a region in common where one of said items occludes visibility of the other of said items as seen from the viewpoint;
decoding a machine readable code in said region of the frame; and
determining whether said region of the frame depicts part of the first item or depicts part of the second item.

42. A method comprising the acts:
receiving image data depicting first and second items from a camera viewpoint, the first and second items overlapping as depicted in the image data, with a first region of the first item occluding a pixel-corresponding region of the second item and causing the second item to be depicted as two disjoint regions;
decoding a first machine readable code from depiction of the first region, decoding a second machine readable code from depiction of one of said disjoint regions, and decoding a third machine readable code from depiction of the other of said disjoint regions; and
identifying in a tally one instance of the first item and one instance of the second item, despite said decoding of three machine readable codes.

43. The method of claim 0 in which the first and second items are two instances of a single type of object, and the method includes identifying two instances of said single type of object in said tally.

44. The method of claim 0 in which said single type of object is a retail object, and the method includes charging a consumer for two instances of said retail object.

45. The method of claim 0 in which said first and second items are first and second retail objects, and the method includes charging a consumer for said first and second retail objects.

46. A method comprising the acts:
receiving an image frame from a first camera viewing retail checkout including one or more objects and (i) comparing the first image frame with a corresponding reference image frame to identify one or more regions of contiguous pixels having values in the first image frame that differ from values of spatially-corresponding pixels in the corresponding reference image frame by more than a threshold amount; and (ii) counting the number of said regions to yield a first count;
receiving a further image frame from each of one or more additional cameras viewing said retail checkout, and for each further image frame (i) comparing the further image frame with a corresponding reference image frame to identify one or more regions of contiguous pixels having values in the further image frame that differ from values of spatially-corresponding pixels in the corresponding reference image frame by more than a threshold amount; and (ii) counting the number of said regions to yield a further count; and
determining a largest count from among said counts;
wherein each of said cameras views the retail checkout along a viewing axis that is non-parallel to the viewing axis of each of the other cameras, and said largest count serves as a count of objects on the retail checkout.

47. The method of claim 0 in which the largest count is two or more.

48. The method of claim 0 in which two objects are present at the retail checkout, each marked with a 2D code conveying a Global Trade Item Number (GTIN), and the GTINs conveyed by the two objects are identical, wherein determining said largest count assures that the two objects will not be mistaken as one single object in an object tally.

49. The method of claim 0 in which said additional cameras number at least two.

50. The method of claim 0 in which the largest count, N, is at least two, and the method includes processing the image frame that yielded the largest count to identify N object sub-regions, applying a digital watermark detection process to pixel data within each of said N object sub-regions, and not applying a digital watermark detection process to pixel data within a region of said frame that is outside each of said N object sub-regions.

51-53. (canceled)

54. The method of claim 46 in which the threshold amount comprises an expected noise margin.

55. The method of claim 46 in which the retail checkout comprises a checkout surface on which the one or more objects are present.

56. The method of claim 45 in which the retail checkout utilizes a basket or cart.
